(19) United States
(12) Patent Application Publication
(10) Pub. No.: US 2026/0012974 A1
(43) Pub. Date: Jan. 8, 2026

(54) NON-PRIMARY CHANNEL ACCESS FOR WIRELESS NETWORK

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Rubayet Shafin, Allen, TX (US); Peshal Nayak, Plano, TX (US); Yue Qi, Plano, TX (US); Bilal Sadiq, Frisco, TX (US)

(21) Appl. No.: 19/251,584

(22) Filed: Jun. 26, 2025

Related U.S. Application Data
(60) Provisional application No. 63/668,698, filed on Jul. 8, 2024.
(60) Provisional application No. 63/679,345, filed on Aug. 5, 2024.
(60) Provisional application No. 63/767,325, filed on Mar. 5, 2025.
(60) Provisional application No. 63/775,749, filed on Mar. 21, 2025.

(51) Int. Cl. H04W 74/0808; H04W 74/00

(52) U.S. Cl. CPC H04W 74/0808; H04W 74/004

(57) ABSTRACT

A station (STA) includes a memory and a processor, the processor to cause receive, a frame associated with initiating a non-primary channel access (NPCA) operation from an access point (AP) that supports NPCA operation, the frame indicating a NPCA primary channel that the AP and the STA switch to for the NPCA operation. The processor is further to cause switching, at a switch time, from a basis service set (BSS) primary channel to the NPCA primary channel based at least in part on receiving the frame. The processor is further to cause initiating a transmission on the NPCA primary channel based on an enhanced distributed channel access (EDCA) parameters associated with the NPCA primary channel. The processor is further to cause an end of transmission on the NPCA primary channel and to cause switching to the BSS primary channel.

### CROSS-REFERENCE TO RELATED APPLICATION(S)

This application claims the benefit of priority from U.S. Provisional Application No. 63/668,698, entitled “CHANNEL ACCESS IN WI-FI NON-PRIMARY CHANNEL ACCESS PROCEDURE,” filed Jul. 8, 2024; U.S. Provisional Application No. 63/679,345, entitled “CHANNEL ACCESS IN WI-FI NON-PRIMARY CHANNEL ACCESS PROCEDURE,” filed Aug. 5, 2024; U.S. Provisional Application No. 63/767,325, entitled “CHANNEL ACCESS IN WI-FI NON-PRIMARY CHANNEL ACCESS PROCEDURE,” filed Mar. 5, 2025; and U.S. Provisional Application No. 63/775,749, entitled “CHANNEL ACCESS IN WI-FI NON-PRIMARY CHANNEL ACCESS PROCEDURE,” filed Mar. 21, 2025, all which are incorporated herein by reference in their entirety.

### TECHNICAL FIELD

This disclosure relates generally to a wireless communication system, and more particularly to, for example, but not limited to, non-primary channel access in wireless communication systems. Some aspects are related to a procedure for channel access during the non-primary channel access operation.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

In some examples, the AP can enable a non-primary channel access (NPCA) operation. During the operation, the AP and associated non-APs that support NPCA can switch to one of a back-up primary channel for performing frame exchanges, while treating the backup channel as a temporary primary channel if the primary channel is busy. In such embodiments, the AP can maintain the back-up primary channel as the temporary primary channel until the end of a duration on the primary channel—e.g., until the primary channel is no longer busy for example. However, it is unclear how channel contention is performed during the NPCA operation. Additionally, it is unclear how to reduce a chance of transmission failure. In that, current NPCA operation definitions do not indicate when the channel access on the back-up primary channel is initiated or when the transmission is ended. Accordingly, additional procedures regarding the NPCA operation are desired.

The description set forth in the background section should not be assumed to be prior art merely because it is set forth in the background section. The background section may describe aspects or embodiments of the present disclosure.

### SUMMARY

An aspect of the present disclosure provides for a station (STA) in a wireless network including a memory and a processor coupled to the memory, the processor to cause receiving a frame associated with initiating a non-primary channel access (NPCA) operation from an access point (AP) that supports NPCA operation, the frame indicating a NPCA primary channel that the AP and the STA switch to for the NPCA operation, switching, at a switch time, from a basic service set (BSS) primary channel to the NPCA primary channel based at least in part on receiving the frame, and initiating a transmission on the NPCA primary channel based on an enhanced distributed channel access (EDCA) parameters associated with the NPCA primary channel.

In an embodiment, the initiating the transmission after switching at the switch time includes initializing a contention window based on the EDCA parameters associated with the NPCA primary channel.

In an embodiment, the frame includes information indicating one or more channels that are punctured.

In an embodiment, the processor is further to cause transmitting one or more physical layer protocol data units (PPDUs) on one or more channels during the NPCA operation, wherein the one or more channels include at least the NPCA primary channel, the one or more channels are within a BSS bandwidth, and the one or more channels do not include a channel that is punctured.

In an embodiment, the processor is further to cause initiating a transmission on the NPCA primary channel to the AP after a NPCA switching delay time of the AP elapses since the switch time.

In an embodiment, the processor is further to cause receiving, from the AP, an indication enabling a mode of operation for the NPCA operation, wherein the mode of operation disables untriggered uplink (UL) transmissions on the NPCA primary channel by the STA.

In an embodiment, the processor is further to cause receiving, from the AP, a trigger frame soliciting an uplink transmission and initiating a transmit opportunity (TXOP) on the NPCA primary channel based on receiving the trigger frame and a mode of operation for the NPCA operation.

In an embodiment, the processor is further to cause transmitting, to the AP, an NPCA initial control frame that solicits a response from the AP and receiving, from the AP, a downlink frame in response to the NPCA initial control frame.

In an embodiment, the frame further includes an indication of a deferral period the STA is to wait upon being ready to transmit on the NPCA primary channel before initiating a transmit opportunity (TXOP).

In an embodiment, the processor is further to cause detecting a transmission on the NPCA primary channel, wherein the transmission is not from within a BSS associated with the AP, determining a duration of the transmission the NPCA primary channel, comparing the duration of the transmission with a threshold value, wherein if the duration of the transmission is above the threshold, switching to the BSS primary channel or if the duration of the transmission is below the threshold, remaining on the NPCA primary channel.

An aspect of the present disclosure provides for a memory and a processor coupled to the memory, the processor to cause transmitting a frame associated with initiating a non-primary channel access (NPCA) operation to one or more associated stations (STAs) that support NPCA operation, the frame indicating an NPCA primary channel that the AP and the STA switch to from a basic service set (BSS) primary channel for the NPCA operation and initiating a transmission on the NPCA primary channel to initiate a data exchange with the one or more associated STAs based on an enhanced distributed channel access (EDCA) parameters associated with the NPCA primary channel.

In an embodiment, the frame includes information indicating one or more channels that are punctured.

In an embodiment, the processor is further to cause transmitting one or more physical layer protocol data units (PPDUs) on one or more channels during the NPCA operation, wherein the one or more channels include at least the NPCA primary channel, the one or more channels are within a BSS bandwidth, and the one or more channels do not include a channel that is punctured.

In an embodiment, the AP initiates the transmission on the NPCA primary channel to the one or more associated STAs after an NPCA switching delay time of each STA of the one or more associated STAs, which are expected recipients of the transmission, elapses since a switch time associated with transitioning from the BSS primary channel to the NPCA primary channel.

In an embodiment, the processor is further to cause transmitting, to the one or more associated STAs, an indication enabling a mode of operation for the NPCA operation, wherein the mode of operation disables untriggered uplink (UL) transmissions on the NPCA primary channel by the STA.

In an embodiment, the processor is further to cause transmitting, to the one or more associated STAs, a trigger frame soliciting an uplink transmission and receiving, from the one or more associated STAs, the uplink transmission based at least in part on transmitting the trigger frame and a mode of operation for the NCPA.

An aspect of the present disclosure provides for a method performed by a station (STA) in a wireless network including receiving a frame associated with initiating a non-primary channel access (NPCA) operation from an access point (AP) that supports NPCA operation, the frame indicating a NPCA primary channel that the AP and the STA switch to for the NPCA operation, switching, at a switch time, from a basic service set (BSS) primary channel to the NPCA primary channel based at least in part on receiving the frame, and initiating a transmission on the NPCA primary channel based on an enhanced distributed channel access (EDCA) parameters associated with the NPCA primary channel.

In an embodiment, the switching at the switch time includes initializing a contention window based on the EDCA parameters associated with the NPCA primary channel.

In an embodiment, the frame includes information indicating one or more channels that are punctured. In an embodiment, the method further includes transmitting one or more physical layer protocol data units (PPDUs) on one or more channels during the NPCA operation, wherein the one or more channels include at least the NPCA primary channel, the one or more channels are within a BSS bandwidth, and the one or more channels do not include a channel that is punctured.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of a secondary channel access in accordance with an embodiment.

FIG. 5 shows an example of an EMLSR operation in accordance with an embodiment.

FIG. 6 shows an example of an EMLMR operation in accordance with an embodiment.

FIG. 7 shows an example wireless network in accordance with an embodiment.

FIG. 8 shows an example primary and backup channel pairing in accordance with an embodiment.

FIG. 9 shows an example NPCA notification frame in accordance with an embodiment.

FIG. 10 shows an example procedure for NPCA switch time in accordance with an embodiment.

FIG. 11 shows an example procedure for NPCA switch time in accordance with an embodiment.

FIGS. 12A and 12B show example STA channel contention in accordance with an embodiment.

FIGS. 13A and 13B show example trigger-based NPCA transmissions in accordance with an embodiment.

FIG. 14 shows an example non-trigger based NPCA transmission in accordance with an embodiment.

FIG. 15 shows another example process for non-primary channel access in accordance with an embodiment.

FIG. 16 shows another example process for non-primary channel access in accordance with an embodiment.

FIG. 17 shows another example process for non-primary channel access in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

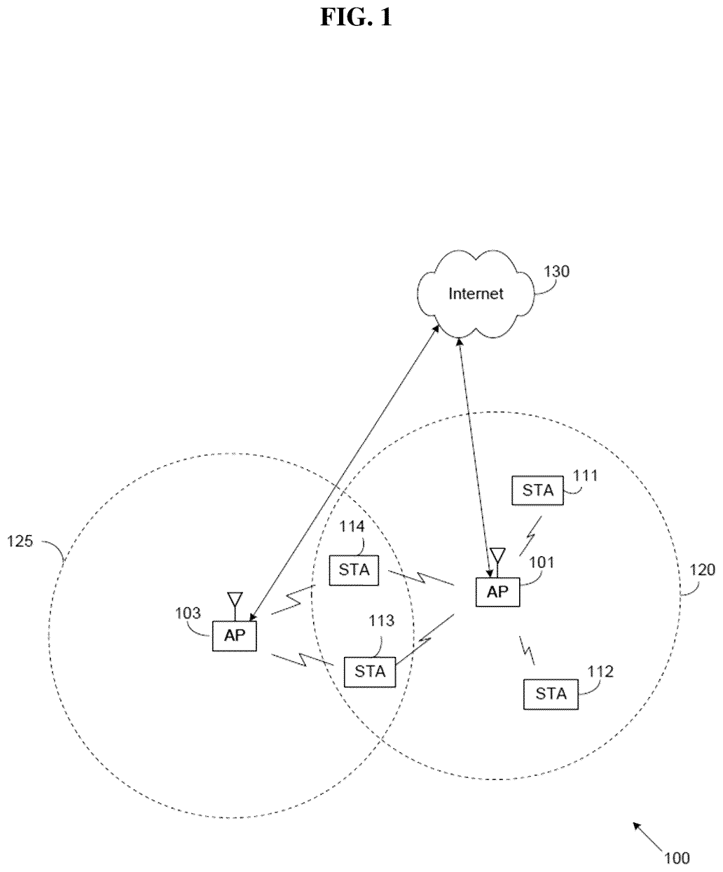

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

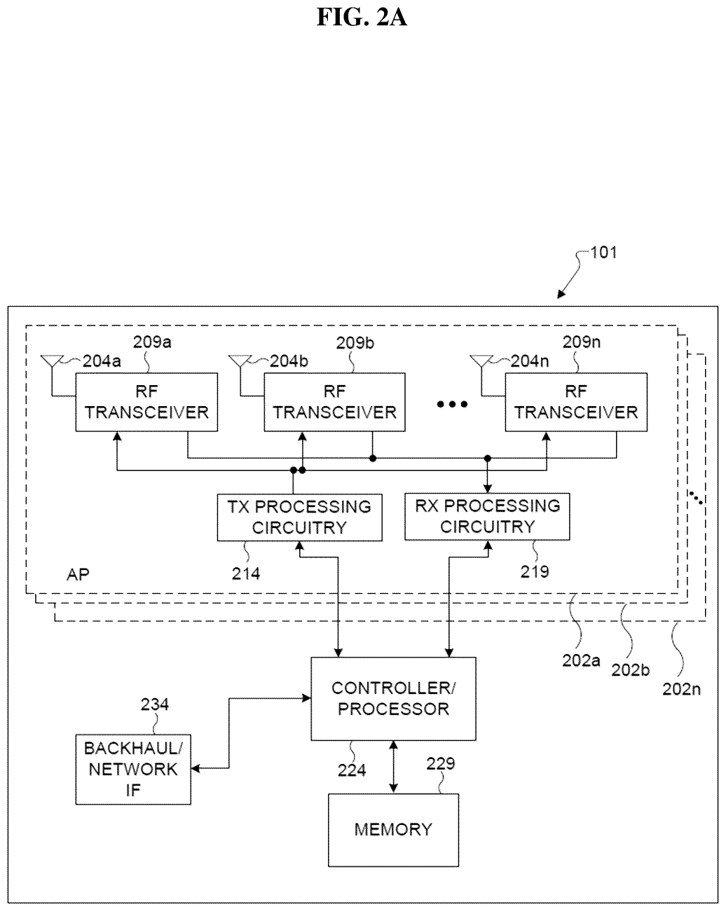

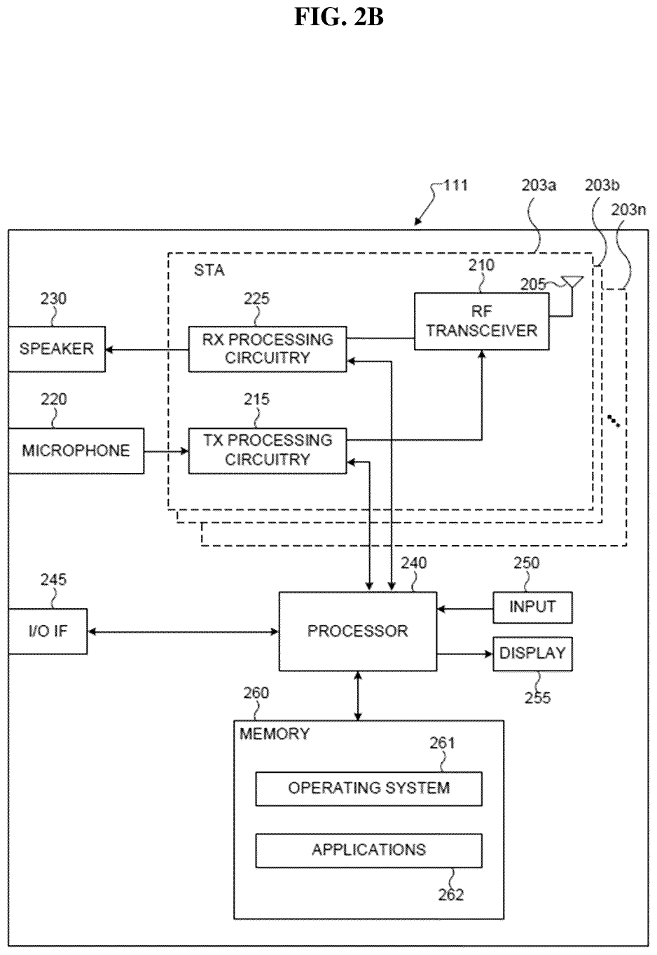

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiments, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

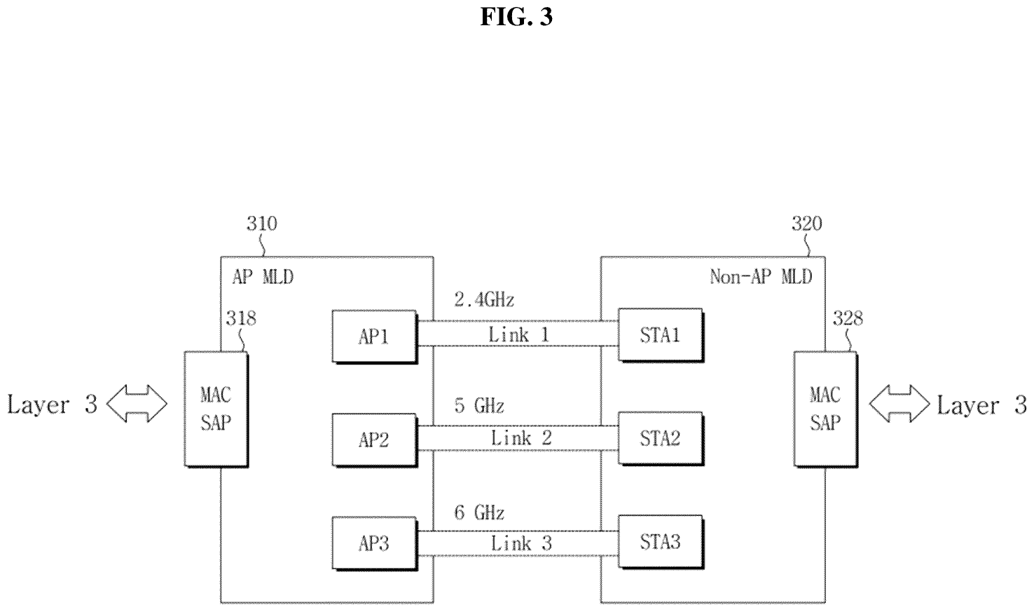

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.1, “Wireless LAN Medium Access Control (MAC) and Physical Layer (PHY) Specifications.”

In at least one embodiment, before a Wi-Fi standard 802.11n (e.g., Wi-Fi standards up to 802.11g), a Wi-Fi device was allowed to use up to 20 megahertz (MHz) of operating bandwidth. In Wi-Fi standard 802.11n, the concept of channel bonding was introduced to increase throughput. In at least one embodiment, channel bonding refers to a wireless device opportunistically bonding a non-primary channel along with a primary 20 MHz to transmit packets with a higher bandwidth. In at least one embodiment, a benefit of channel bonding can include increased throughput if a neighbor basic service set (BSS) is idle. In one embodiment, another benefit of channel bonding can include improved transmission efficiency although it may cause increased latency. For example, if the neighboring BSS has traffic, channel bonding can increase throughput but cause the neighboring BSS to be unable to access the channel by taking away the neighboring BSS primary channel. In some embodiments, the amount of channel bonding can depend on a device capability or Wi-Fi generation specification. For example, for the Wi-Fi standard 802.11n, channel bonding up to 40 MHz is considered. In other embodiments, the Wi-Fi standard 802.11ac expands the channel bonding up to 80 MHz and 160 MHZ, 802.11ax expanded channel bonding up to 160 MHz and introduced puncturing (e.g., transmit on a portion of a spectrum channel if some of the channel is being used), and 802.11be introduced channel bonding up to 320 MHz and enabled puncturing to be applicable to more configurations.

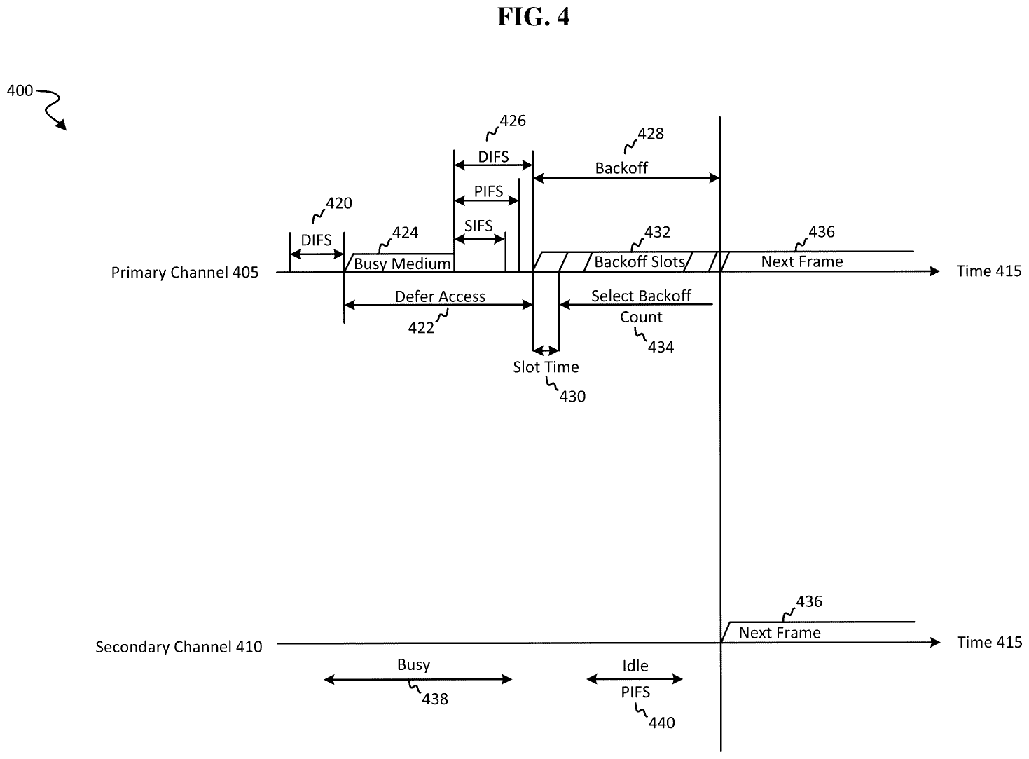

FIG. 4 shows an example of a secondary channel access 400 in accordance with an embodiment. The secondary channel access 400 depicted in FIG. 4 is for explanatory and illustration purposes and FIG. 4 does not limit the scope of this disclosure to any particular implementation. In some embodiments, the secondary channel access 400 illustrates an example of channel bonding. In one embodiment, secondary channel access 400 illustrates a channel bonding between a primary channel 405 and a secondary channel 410.

In at least one embodiment, a Wi-Fi device performs a clear channel assessment (CCA) procedure to determine if a channel is busy or idle before performing a transmission on a 20 MHz or wider channel. In at least one embodiment, the Wi-Fi device can perform the CCA via a CCA preamble detection (CCA PD) or CCA energy detection (CCA ED). In one embodiment, when the Wi-Fi device is performing CCA PD, the Wi-Fi device detects a channel as being busy when it observes a preamble on a channel that can be used to set a network allocation vector (NAV) time. In other embodiments, when the Wi-Fi device is performing CCA ED, the Wi-Fi device detects a channel as being busy when a received signal strength exceeds a CCA-ED threshold as given by a predetermined threshold value (e.g., a predetermined orthogonal frequency-division multiplexing (OFDM) ED threshold as defined by dot11OFDMEDThreshold). For example, the Wi-Fi device determines a 20 MHz primary channel 405 is busy if the received signal strength exceeds the predetermined threshold, determines a 20 MHz secondary channel 410 (if present) is busy if the received signal strength exceeds the predetermined threshold, determines a 40 MHz secondary channel 410 (if present) is busy if the received signal strength exceeds the predetermined threshold plus 3 decibels (dB), and determines a 80 MHz secondary channel 410 (if present) is busy if the received signal strength exceeds the predetermined threshold plus 6 dB. In such embodiments, the WiFi device determines the channel is idle if the above conditions are not met—e.g., the Wi-Fi device determines the 20 MHz primary channel 405 is idle if the received signal strength does not exceed the predetermined threshold, etc.

In at least one embodiment, if an STA supports multiple channel widths, the STA can obtain an enhanced distributed channel access (EDCA) transmission opportunity (TXOP) based on an activity of the primary channel 405. In at least one embodiment, the STA can win the TXOP based on a conventional random backoff procedure 428. In at least one embodiment, the STA can utilize a wider bandwidth transmission during the TXOP obtained based on the idle state of the primary channel 405. In such embodiments, the STA can utilize the wider bandwidth based on performing a CCA on the secondary channel 410 (e.g., a secondary 20 MHz, 40 MHz, or 80 MHz channel 410). In at least one embodiment, the STA can use the wider bandwidth transmission if the secondary channel 410 is idle during a point coordination function (PCF) inter-frame space (PIFS) interval 426 preceding a start of the TXOP on the primary channel 405. For example, initially the primary channel 420 is in an DIFS interval 420 while the secondary channel 410 is in a busy state 438. In at least one embodiment, after the DIFS interval 420, the primary channel 405 can defer access 422 based on a busy medium 424 or one or more inter-frame spaces 426 (e.g., based on a short inter-frame space (SIFS), a PSIF, or DIFS 426). In at least one embodiment, during the backoff period 428 of the primary channel 405, the STA can generate a random backoff count 434 or number and decrement the backoff count 434 by one for every slot time 430 the primary channel 405 is idle—e.g., decrement the backoff count 434 based on a lapse of a backoff slot 432 while the primary channel is idle. In at least one embodiment, the secondary channel 410 can be in an idle state during a PIFS 440 while the primary channel 405 is performing the backoff 428. In such embodiments, as the primary channel 405 has won a TXOP and is performing a backoff 428 while the secondary channel 410 is idle, the STA can perform channel bonding. That is, the STA can transmit the next frame 436 on both the primary channel 405 and secondary channel 410 via channel bonding.

In at least one embodiment, since the channel bonding increases the bandwidth of the next transmitted frame 436, the preamble is usually duplicated on all 20 MHz channel or bands used for transmission to enable reception of the next frame 436. In at least one embodiment, the primary channel 405 is used for transmission—e.g., management and control frames are transmitted on the primary channel 405 and can be duplicated on other secondary channels via a duplicate physical layer protocol data unit (PPDU) format.

In conventional solutions, the AP or an associated non-AP STA can transmit on any non-primary channel if it also transmits on the primary channel. That is, the STA cannot perform a transmission even if a secondary channel 410 is idle while the primary channel 405 is busy due to an overlapping basic service set (OBSS) TXOP. Accordingly, this can increase channel access delays and reduce an efficiency of channel utilization. To overcome this deficiency, a non-primacy channel access (NPCA) mechanism has been proposed. In an embodiment, during the NPCA if an OBSS transmission occupies the primary channel 405 of the AP for a certain duration, the AP and associated non-AP STAs (e.g., that support NPCA) can switch from the primary channel 405 to one of a back-up primary channel for performing the frame exchange. That is, the AP can treat the backup channel temporarily as the primary channel 405 until the end of the busy duration of the primary channel 405. Accordingly, when the AP enables the NPCA operation, the AP can disclose one or more back-up 20 MHz primary channels.

In at least one embodiment, the AP can continue utilizing the back-up primary channel until either an end of a PPDU duration set by the OBSS transmission on the primary channel 405 or an end of a NAV duration set by the OBSS transmission on the primary channel 405. In at least one embodiment, these variations can be referred to as PPDU duration based NPCA or NAV duration based NPCA, respectively. In at least one embodiment, a duration during which the transmission occurs on the backup primary channel is referred to as an NPCA duration. In at least one embodiment, a time at which the AP transitions (e.g., returns) back to the primary channel is referred to as an NPCA switchback time. In at least one embodiment, additional procedures for the NPCA operation with regard to the initiation, procedure, and termination of the NPCA are desired.

For example, the PPDU can indicate the NAV duration in one of two ways. In the first way, (e.g., before 802.11ax introducing high efficiency (HE), the NAV duration is set from a duration field of a medium access control (MAC) layer header. However, since the MAC header is not duplicated on all of the 20 MHz channels, the STA cannot set the NAV duration from a pre-HE TXOP another BSS unless the STA's operating bandwidth is greater than or equal to a PPDU BW (e.g., STA Operating Bandwidth ≥ PPDU BW). In one embodiment, an exception can occur if the transmission are in a non-high throughput (HT) duplicated PPDU format—e.g., used for clear to send (CTS) and request to send (RTS), etc. In a second way, (e.g., for HE, extremely high throughput (EHT)), the NAV duration is indicated in a TXOP subfield of a HE-SIG-A2 (High efficiency signal A2) or universal signal 1 (U-SIG1) field. However, the TXOP subfield granularity of encoding is limited to 8 microseconds (μS) if the TXOP is less than 512 μS and limited to 128 μS for TXOPs greater than 512 μS. In at least one embodiment, the TXOP field is set utilizing a floor function. In such embodiments, the floor function can underestimate the actual duration up to 128 μS (e.g., the size of or larger than the granularity of encoding, leading to inaccuracies).

In at least one embodiment, the STA can fail to observe the transmission on a medium for an extended duration. For example, the STA can transition to or be in a doze state, suffering strong interference from transmissions on another link, or strong interference from a peer-to-peer (P2P) transmission, etc. These interferences, however, can cause a loss of medium or loss of NAV synchronization at the STA. That is, the STA can fail to have an updated value of the NAV. To reduce interference to ongoing transmissions, mechanisms are in place to make the channel access conservative for STAs that lost medium or NAV synchronization until they obtain synchronization with the medium. For example, the mechanism could include causing an STA transitioning from a doze state to an awake state to perform a clear channel assessment (CCA) until a frame is detected by which the STA can set its NAV or until a period of time indicated by a synchronization delay value (NAVSyncDealy) from a MAC sublayer management entity (MLME) join request has elapsed before the STA can begin transmission. That is, after performing the mechanism, the STA can contend for channel access. In at least one embodiment, the synchronization delay value (e.g., NAVSyncDealy) is a delay (in microseconds) used prior to transmitting a frame when transitioning from the doze state to the awake state, if no frame is detected by which the NAV can be set. In other examples, the mechanism could include a medium synchronization recovery procedure. That is, when an STA is unable to detect activity on a channel for a relatively shorter period of time (e.g., due to cross-link interference), the STA is assumed to suffer a loss of medium synchronization. In such embodiments, to prevent the loss of medium synchronization from affecting other transmissions in the network, the STA performs the medium synchronization recovery procedure by initializing a timer (e.g., a MeidumSyncDelay timer). In at least one embodiment, the STA can utilize a conservative channel access procedure until the expiry of the timer or recovery of the medium synchronization, whichever occurs first. In at least one embodiment, the initiation of a TXOP by the non-AP during the conservative channel access procedures (e.g., while the MediumDelaySynch timer is greater than 0) includes at least one of transmission of a request to send (RTS) as a first frame to gain the TXOP, refraining from attempting more than max TXOP value (e.g., a medium sync delay (MSD) TXOP value (dott11MSDTXOPMax) with a default of 1), or using a CCA ED threshold (e.g., CCA_ED) equal to a MSD OFDM value (e.g., dot11MSDOFDMEDthreshold, having a default value of −72 decibel-milliwatts (dBm)).

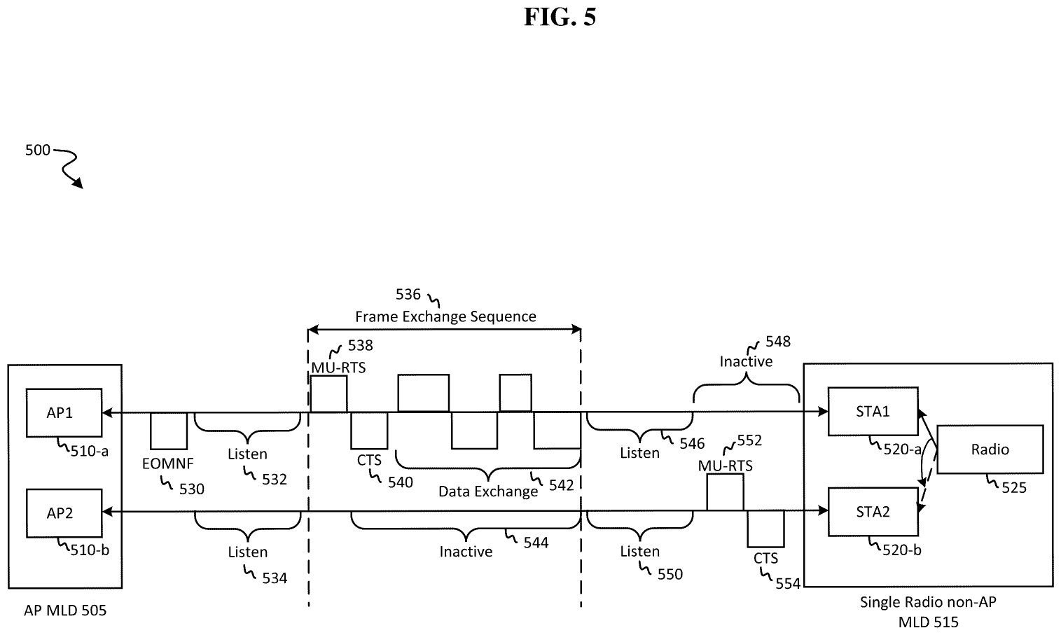

FIG. 5 illustrates an example EMLSR operation 500 in accordance with an embodiment. In at least one embodiment, the EMLSR operation depicted in FIG. 5 is for explanatory and illustration purposes and FIG. 5 does not limit the scope of this disclosure to any particular implementation. Although one or more operations are described or shown in a particular sequential order, in other embodiments the operations may be rearranged in a different order, which may include performance of multiple operations in at least partially overlapping time periods. In at least one embodiment, the EMLSR operation 500 is between an AP multi-link device (MLD) 505 and a single radio non-AP MLD 515. In at least one embodiment, the AP MLD 505 can include a first AP 510-a and a second AP 510-b. In one embodiment, the single radio non-AP MLD 515 can include a first station 520-a, a second station 520-b, where the first STA 520-a and second STA 520-b are coupled to a radio 525. In at least one embodiment, the first AP 510-a is coupled with the first STA 520-a over a first link and the second AP 510-b is coupled with the second STA 520-b over a second link.

In at least one embodiment, to improve channel access capabilities with limited hardware costs, power consumption, or to increase spectral efficiency, a non-AP MLD 515 can support an operating mode called enhanced multi-link single radio (EMLSR) mode. In at least one embodiment, during the EMLSR mode, the non-AP MLD 515 acts like a single radio device that performs channel sensing and reception of elementary packets on multiple bands or links simultaneously. However, during the EMLSR mode, the non-AP MLD 515 can perform reliable data communication on one link at a time. Accordingly, by opportunistically selecting a link for data communication where it wins a channel contention, the EMLSR can increase system spectral efficiency.

In at least one embodiment, if the single radio non-AP MLD 515 intends to operate in the EMLSR mode, the STA 520 (e.g., first STA 520-a) can transmit an enhanced multi-link (EML) operating mode notification frame (EOMNF) 530 to the AP 510 (e.g., first AP 510-a) with an EMLSR mode subfield in a EML control field of a frame set to 1. Once the EMLSR mode is enabled, the STAs 520 of single radio non-AP MLD 515 are in listen mode by default—e.g., the first STA 520-a is in a listen mode 532 and the second STA 520-b is in a listen mode 534. In at least one embodiment, by listening as the default, the single radio non-AP MLD 515 is capable of channel sensing and reception of elementary packets.

In at least one embodiment, the single radio non-AP MLD 515 can obtain a TXOP on any one its links. For example, the single radio non-AP MLD 515 can obtain a TXOP for the first link, coupling the first AP 510-a and the first STA 520-a. In such embodiments, the AP MLD 505 can indicate a frame exchange sequence 536 with the single radio non-AP MLD 515. In at least one embodiment, the AP MLD 510 can initiate the frame exchange sequence 536 with single radio non-AP MLD 515 by transmitting an initial control frame (ICF). In one embodiment, the ICF is a multi-user request to send (MU-RTS) frame 538 transmitted on the first link. In at least one embodiment, the first STA 520 can reply to the MU-RTS frame 538 with a clear to send (CTS) frame 540. After the control frame exchange, following a short delay, the single radio non-AP MLD 515 is capable of transmitting and sending data during the data exchange 542 over the first link. As described above, because data is transmitted reliably on a single link at a time, all other EMLSR enabled links of the single radio non-AP MLD 515 remain inactive during the frame exchange sequence. For example, the second link is in an inactive phase 544 while the frame exchange sequence 536 takes place on the first link. In at least one embodiment, at the end of the frame exchange sequence 536, all EMLSR enabled STAs 520 of single radio non-AP MLD 515 switch back to the listening mode to either win a new TXOP for uplink transmission or look for another initial control frame from the AP MLD. For example, the first STA 520-a can transition to a listen mode 546 and the second STA 520-b can transition to a listen mode 550 following the frame exchange sequence 536. In at least one embodiment, the second STA 520-b receives a control frame from the second AP 510-b—e.g., receives the MU-RTS frame 552. In such embodiments, the first link can transition to an inactive phase 548 while the second STA 520-b can respond with a CTS 554.

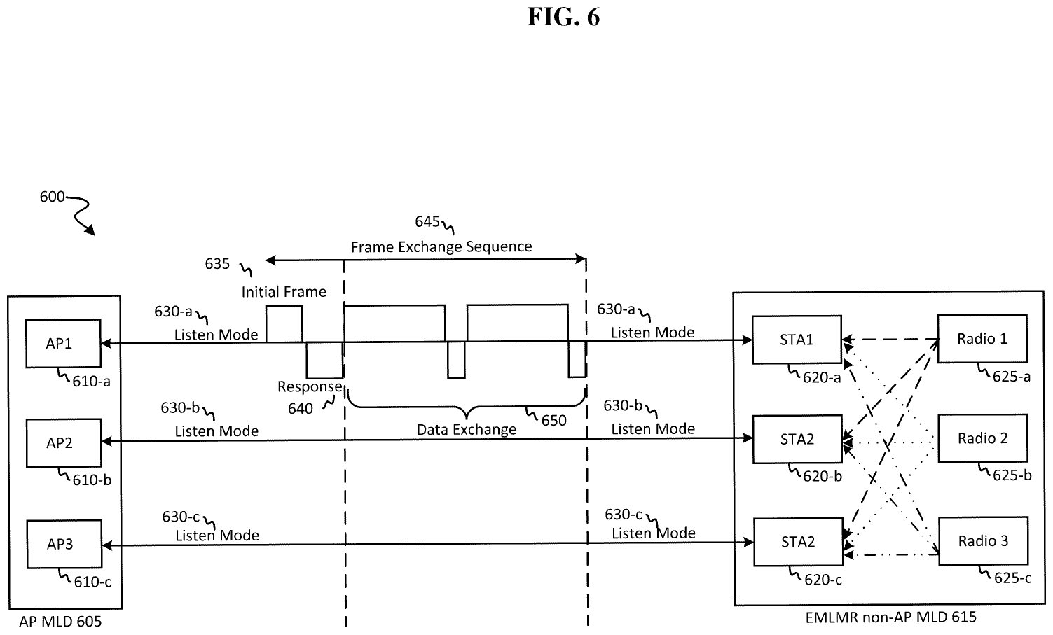

FIG. 6 illustrates an example EMLMR operation 600 in accordance with an embodiment. In at least one embodiment, the EMLMR operation depicted in FIG. 6 is for explanatory and illustration purposes and FIG. 6 does not limit the scope of this disclosure to any particular implementation. Although one or more operations are described or shown in a particular sequential order, in other embodiments the operations may be rearranged in a different order, which may include performance of multiple operations in at least partially overlapping time periods. In at least one embodiment, the EMLMR operation 600 is between an AP multi-link device (MLD) 605 and an EMLMR non-AP MLD 615. In at least one embodiment, the AP MLD 605 can include a first AP 610-a, a second AP 610-b, and a third AP 610-c. In one embodiment, the EMLMR non-AP MLD 615 can include a first station 620-a, a second station 620-b, and a third station 620-c, where the first STA 620-a, the second STA 620-b, and the third STA 620-c are coupled to a first radio 625-a, a second radio 625-b, and a third radio 625-c. In at least one embodiment, the first AP 610-a is coupled with the first STA 610-a over a first link, the second AP 610-b is coupled with the second STA 620-b over a second link, and the third AP 610-c is coupled with the second STA 620-c over a third link.

In at least one embodiment, to improve a number of supported modulation coding scheme (MCS) and number of spatial streams (NSS) opportunistically (e.g., and thus improving spectral efficiency), a non-AP MLD (e.g., EMLMR non-AP MLD 615) can support called enhanced multi-link multi-radio (EMLMR) mode. In at least one embodiment, during the EMLMR mode, the EMLMR non-AP MLD 615 can move radios across from its other links to the link transmitting and receiving information to increase the supported MCS and NSS on that link. In at least one embodiment, the EMLMR non-AP MLD's 615 MCS and NSS capability on each link with a single radio are referred to as “basic capabilities” (e.g., before radios are moved from across links) and the EMLMR non-AP MLD's 615 MCS and NSS capability on a link after additional radios have been switched to the link are referred to as “enhanced capabilities.” In at least one embodiment, a set of links that support the EMLMR capabilities (e.g., enhanced capabilities or the ability to move radios to and from) are referred to as EMLMR links.

For example, when initiating the EMLMR mode, each STA 620 of EMLMR non-AP MLD 615 is in a listening mode—e.g., first STA 620-a is in a listening mode 630-a, second STA 620-b is in a listening mode 630-b, and third STA 620-c is in a listening mode 630-c. In at least one embodiment, during a listening mode 630, the EMLMR non-AP MLD 615 is capable of channel sensing and transmitting and receiving packets on the EMLMR links per the basic capabilities of each link. In one embodiment, after winning a TXOP on any EMLMR link associated with the EMLMR non-AP MLD 615, the AP MLD 605 can initiate a frame exchange sequence 645 with the EMLMR non-AP MLD 615 by transmitting an initial frame 635. As illustrated in FIG. 6, the EMLMR non-AP MLD 615 can win the TXOP on the first link. In such embodiments, the first AP 610-a can transmit an initial frame (IF) 635 to the first STA 620-a. In some embodiments, the IF 635 can be an example of a MU-RTS frame transmitted. In at least one embodiment, the first STA 620-a can receive the IF 635 and transmit a response 640. In at least one embodiment, the EMLMR non-AP MLD 615 can also switch other radios 625 to the first link. For example, during the frame exchange 645, the EMLMR non-AP MLD 615 can utilize the first radio 625-a, the second radio 625-b, and the third radio 625-c, for the first link and the first STA 620-a. Accordingly, the STA 620-a can perform the frame exchange sequence 645 per the enhanced capabilities. In at least one embodiment, the IF 635 can include sufficient padding to provide time for the EMLMR non-AP MLD 615 to switch the radios 625 to the first link.

In at least one embodiment, after the frame exchange sequence 645, all EMLMR non-AP MLD 615 STAs 620 can transition back to the listening mode 630—e.g., first STA 620-a is in a listening mode 630-a, second STA 620-b is in a listening mode 630-b, and third STA 620-c is in a listening mode 630-c at the end of the data exchange sequence 645.

In at least one embodiment, a restricted target wake time (rTWT) is a key feature to provide better support for latency sensitive applications. In at least one embodiment, rTWT offers a protected service period for its affiliated STAs by sending one or more quiet elements to other STAs in the BSS which are not a member of the rTWT. In at least one embodiment, the quiet interval corresponding to the quiet element overlaps with an initial portion of the rTWT service period (SP). Accordingly, the rTWT affiliated scheduled STAs can have more channel access opportunities, helping latency-sensitive traffic flow.

In at least one embodiment, when an AP (e.g., AP 610) has enabled NPCA operations and the primary channel is occupied by an OBSS transmission, the AP and affiliated NPCA supporting STAs (e.g., STAs 620) are allowed to switch to a backup primary channel for performing the channel access. However, it is unclear how channel contention and a chance of transmission failure can be minimized for transmissions on the backup primary channel. In that, it is not clear when a channel access on the backup primary channel is initiated or when the channel access on the backup primary channel is terminated. In at least one embodiment, it is further unclear how the AP can indicate the supported transmission parameters for the backup primary channel. Accordingly, procedures for how to access the backup primary channel are desired.

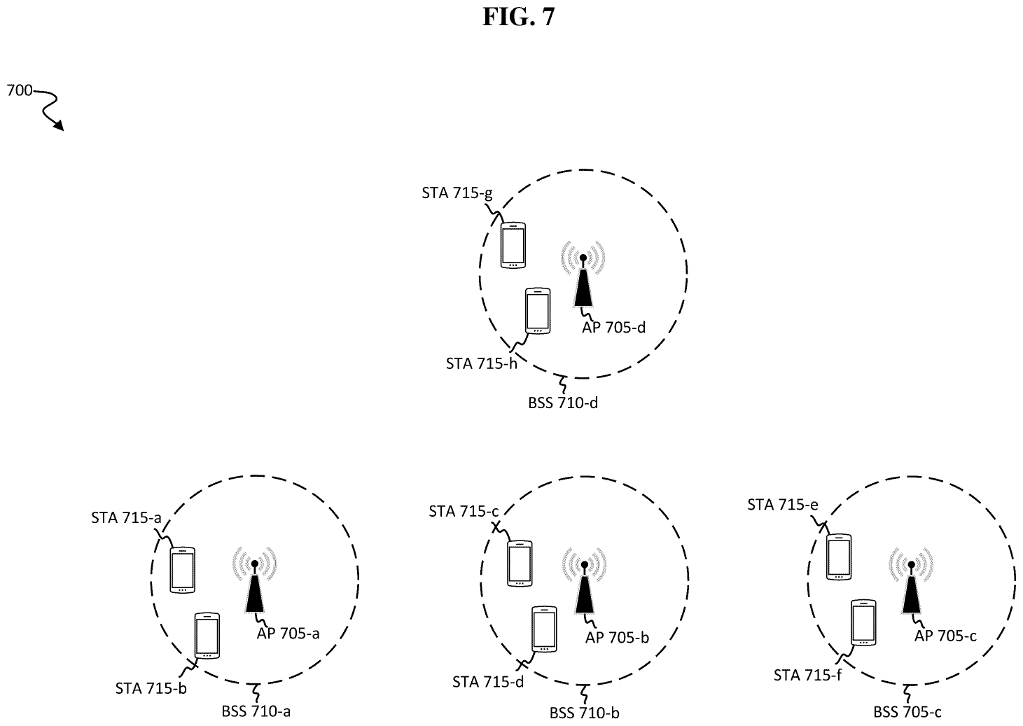

FIG. 7 illustrates an example wireless network 700 in accordance with an embodiment. In at least one embodiment, the wireless network 700 includes one or more basic service sets (BSSs) 710. For example, the wireless network 700 can include a BSS 710-a, BSS 710-b, BSS 710-c, and BSS 710-d. In at least one embodiment, the BSS 710 can overlap with respect to each other. That is, each BSS 710 can contend for the wireless network 700. For example, a first BSS 710-a can be operated by a first AP 705-a. In such embodiments, BSS 710-b, BSS 710-c, and BSS 710-d are overlapping BSS 710 that operate on an overlapping bandwidth. In at least one embodiment, each BSS can include an AP 705 and associated stations (STAs) 715. For example, the first BSS 710-a can include a first AP 705-a affiliated with STA 715-a and STA 715-b. In at least one embodiment, to enhance spectrum utilization and minimize channel access latency, the AP 705 can enable non-primary channel access (NPCA) operations and along with the associated STAs 710 that support NPCA operations and capabilities.

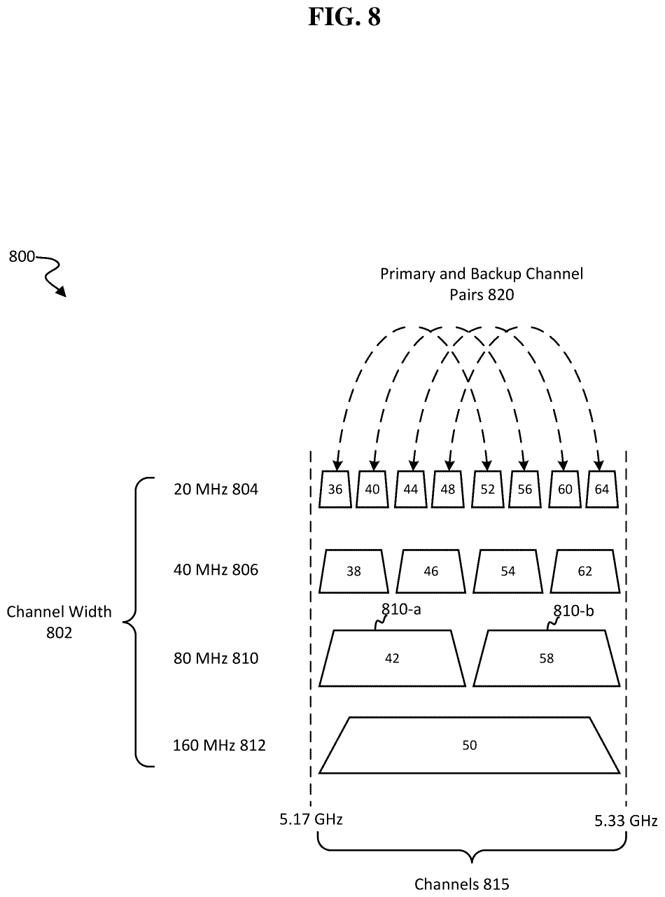

FIG. 8 illustrates an example of a primary and backup channel pairing 800 in accordance with an embodiment. The primary and backup channel pairing 800 depicted in FIG. 8 is for explanatory and illustration purposes and FIG. 8 does not limit the scope of this disclosure to any particular implementation. In at least one embodiment, the primary and backup channel pairing 800 can illustrate a channel width 802—e.g., channel width 20 megahertz (MHz) 804, channel width 40 MHz 806, channel width 80 MHz 810, and channel width 160 MHz 812. In some embodiments, the wireless device can also include a channel width of 320 MHz or higher. In at least one embodiment, there may be one or more channels assigned for each channel width 802. For example, channel width 20 MHz 804 can include channel 36, 40, 44, 48, 52, 56, 60, and 64, channel width 40 MHz 806 can include channels 38, 46, 54, and 62, channel width 80 MHz 810 can include channels 42 and 58, and channel width 160 MHz 812 can include channel 50. In one embodiment, the channels 815 range from a frequency 5.17 gigahertz (GHz) to 5.33 GHz.

In at least one embodiment, an access point (AP) can enable a non-primary channel access (NPCA) operation. In such embodiments, the AP can indicate one or more backup primary channels 815 that can act as a temporary primary channel 815 while a main primary channel of a basic service set (BSS) is occupied by an overlapping BSS (OBSS) transmission.

In at least one embodiment, if all APs in a vicinity (e.g., APs 710 as described with reference to FIG. 7) select a same channel 815 as the backup primary channel 815, it can cause excessive channel contention on the backup primary channel 815. That is, the backup primary channel can also be affected by an OBSS transmission.

Accordingly, an AP can select a primary and backup channel pair 820 based on information the AP collects from neighboring AP's operating channels and the neighboring AP's NPCA backup primary channel (e.g., if any). In at least one embodiment, the AP can collect the neighboring AP's information via a channel scanning procedure or based on an explicit frame exchange between the AP and the neighboring AP. In at least one embodiment, the AP can transmit frames to the neighboring AP to share information and/or negotiate a choice of an NPCA backup primary channel. In one embodiment, the AP can transmit the frames to the neighboring AP during a multi-AP coordination procedure.

In other embodiments, the AP can select primary and backup channel pairs 820 according to an 802.11 family of standards. That is, the standard can define a relationship between a primary channel of the AP and an NPCA backup primary channel of the AP. For example, a relative location of a 20 MHz primary channel 815 within a primary 80 MHz sub-band of the BSS (e.g., 80 MHz sub-band 810-a or 80 MHz sub-band 810-b) can be the same as a relative location of a 20 MHz backup primary channel—e.g., within the 80 MHz sub-band that the backup primary channel belongs to. In one embodiment, as illustrated with respect to FIG. 7, the AP can form primary and backup channel pairs 820 where each primary and backup primary channel are within different 80 MHz 810 sub-bands, but share the same relative location within those respective 80 MHz sub-bands. For example, the AP can select a primary channel ‘36’ and a backup primary channel ‘52’ where both channel 36 is associated with 80 MHz sub-band 810-a and channel 52 is associated with 80 MHz sub-band 810-b—e.g., the primary channel ‘36’ and backup primary channel ‘52’ are within different 80 MHz 810 sub-bands.

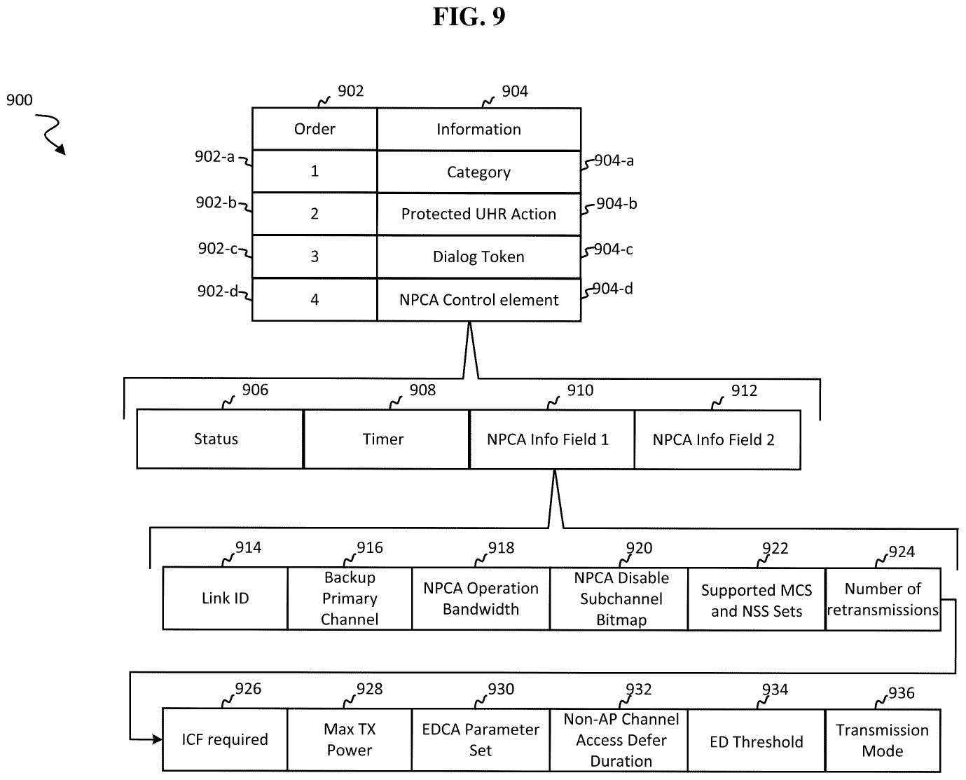

FIG. 9 illustrates an example NPCA notification frame 900 in accordance with embodiments herein. The format depicted in FIG. 9 is for explanatory and illustration purposes. FIG. 9 does not limit the scope of this disclosure to any particular implementation. It should be noted that while the information described herein is described with respect to an NPCA notification frame 900, the information described herein can be transmitted in a different frame or format. That is, an indication for NPCA operations can be in the NPCA notification frame 900 and/or include an NPCA control element in broadcast frames transmitted by an AP or STA—e.g., an NPCA control element in a beacon frame, probe response frame, association (reassociation) response frame, etc. In one embodiment, the NPCA control element can be transmitted as per STA profile sub element (e.g., in a reconfiguration multi-link element). In at least one embodiment, the NPCA notification frame 900 is transmitted by an AP and received by an STA. In other embodiments, the NPCA notification frame 900 can be transmitted by either an AP or STA and received by either an AP or STA.

In at least one embodiment, the NPCA notification frame 900 can include an NPCA control element 904-d signaled as illustrated with respect to the order 902 and information 904. That is, a first order 902-a of one ‘1’ can be associated with category 904-a, a second order 902-b of two ‘2’ can be associated with a protected ultra-high reliability (UHR) action 904-b, a third order 902-c of three ‘3’ can be associated with a dialog token 904-c, and a fourth order 902-d can be associated with the NPCA control element 904-d.

In at least one embodiment, the NPCA notification frame 900 can include a status 906 indicating a status of the NPCA notification frame 900, a timer 908 indicating a time associated with the NPCA notification frame 900, a first NPCA information field 910, and a second NPCA information field 912. In some embodiments, the NPCA notification frame 900 can include additional NPCA information fields (e.g., a third NPCA information field, a fourth NPCA information field, etc.) In one embodiment, each NPCA information field (e.g., first NPCA information field 910 and second NPCA information field 912) corresponds to either a different link or a different backup primary channel for the same link. In at least one embodiment, each NPCA information field (e.g., first NPCA information field 910 and second NPCA information field 912) can include the information described with respect to the first NPCA information field 910 depicted in FIG. 9. That is, each NPCA information field (e.g., the first NPCA information field 910 and second NPCA information field 912) can include several parameters describing channel access procedures on the corresponding backup primary channel as illustrated with respect to the first NPCA information field 910. In at least one embodiment, other naming and associations for each of the subfields described herein is possible. In at least one embodiment, information described in one subfield can be included or transmitted in a different subfield—e.g., FIG. 9 does not limit the scope of this disclosure to any particular implementation.

In at least one embodiment, the first NPCA information field 910 can include a link identification (ID) 914, a backup primary channel 916, an NPCA operation bandwidth 918, an NPCA disable subchannel bitmap 920, supported modulation coding scheme (MCS) and number of spatial streams (NSS) set 922, a number of retransmissions 924, an initial control frame required 926, a maximum power transmission (TX) 928, enhanced distributed channel access (EDCA) parameter set 930, non-AP channel access defer duration 932, an energy detection (ED) threshold 934, and transmission mode 936.

In at least one embodiment, the link ID 914 can identify a link associated with the NPCA operation—e.g., identify the link where the AP or STA is considering performing NPCA switch operation from primary channel to the backup primary channel. That is, for multi-link operations (MLO), parameters can vary link to link and each link can have a separate NPCA control element. In such embodiments, the link is identified in the link ID 914 or it is carried in STA specific sub-elements of an element or frame transmitted. For example, the link can be indicated in a per STA profile sub-element in a basic multi-link (ML) element.

In one embodiment, the backup primary channel 916 can include one or more backup primary channels for the NPCA operation. In one embodiment, the backup primary channels can be indicated using 8-bit channel numbers associated with each backup primary 20 MHz channel. In at least one embodiment, the NPCA operation bandwidth 918 can indicate an NPCA operation bandwidth over which channel bonding is allowed when accessing the backup primary channel. In some embodiments, the NPCA operating bandwidth is signaled using a 3-bit field with each encoding corresponding to a different bandwidth—e.g., corresponding to one of a 20 MHz, 40 MHz, 60 MHz, 80 MHz, 160 MHz, or 320 MHz bandwidth. In at least one embodiment, a component channel can refer to a channel that overlaps with a respective ‘X’ MHz channel overlapping with the backup primary channel, where ‘X’ is a bandwidth indicated above. In at least one embodiment, the NPCA operation bandwidth 918 (e.g., or a different field of the NPCA notification frame 900) can also indicate supported channel widths on the backup primary channel number. In some embodiments, the supported channel widths can be a subset of channel widths smaller than the NPCA operation bandwidth.

In at least one embodiment, the NPCA disable subchannel bitmap 920 indicates 20 MHz channels that are within the NPCA operation bandwidth but for which channel bonding is disallowed during channel access on the backup primary channel. In one embodiment, the NPCA disable bitmap 920 is indicated using a 16-bit bitmap, where each bit of the bitmap indicates a status of each component 20 MHz channel within the NPCA operation bandwidth. That is, when an NPCA STA switches to an NPCA primary channel for NPCA operation, the 20 MHz channels occupied by physical layer protocol data units (PPDUs) transmitted by the STA shall met the condition of not including channels that are indicated as punctured in the disabled subchannel bitmap field in an extremely high throughput (EHT) operation element. In some embodiments, 20 MHz channels that are within the NPCA operation bandwidth but for which channel bonding is disallowed are considered punctured—e.g., such channels can be referred to as punctured channels. That is, the 20 MHz channels for which channel bonding is disallowed are indicated as punctured and marked disabled in the disabled subchannel bitmap field.

In an embodiment, supported MCS and NSS sets 922 indicates the MCS and NSS sets supported by the AP on the backup primary channel number. In at least one embodiment, the supported MCS and NSS sets 922 can be encoded similar to an indication in a capabilities message—e.g., encoding to show the supported MCS and NSS sets 922 is similar to the encoding to show the supported MCS and NSS sets in the capabilities element. In other embodiments, the supported MCS and NSS sets 922 can indicate a max NSS and an applicable MCS that is determined similar to the max NSS and applicable MCS for an operating mode change procedure. In one embodiment, the number of retransmissions 924 can indicate a number of retransmissions that are permitted for transmissions on the backup primary channel.

In one embodiment, ICF required 926 indicates whether an initial control frame is utilized to initiate a transmission on the backup primary channel. In some embodiments, the ICF required 926 is a 1-bit field where a first value (e.g., a ‘0’ or ‘1’) is associated with utilizing an ICF and a second value (e.g., the other of ‘0’ or ‘1’) is associated with not utilizing the ICF. In some embodiments, the max TX power 928 indicates a maximum transmit power to be used for transmissions on the backup primary channel. In some embodiments, the max TX power 928 is a 6-bit field, where the max TX power 928 is set to a value (e.g., field value F_{Val}) and an allowed TX power (P_{TX}) is determined by equation (equation 1):

$${P}_{TX} = - 20 + {F}_{Val} dBm / 20 MHz$$

In at least one embodiment, the EDCA parameter set 930 indicates the EDCA parameters to be used for channel access on the backup primary channel. In at least one embodiment, the EDCA parameter set 930 can include an indication of a max transmission opportunity (TXOP) length, a contention window minimum (e.g., CWₘᵢₙ), a contention window maximum (e.g., CWₘₐₓ), arbitration inter-frame spacing number (AIFSN) parameters, etc. for different access category (AC). That is, when an NPCA STA switches to an NPCA backup primary channel for NPCA operation, once the STA becomes ready to transmit on the NPCA backup primary channel, the STA may initiate a TXOP on the NPCA backup primary channel by following the rules defined in 10.23.2.2 (EDCA backoff procedures) and 10.23.2.4 (obtaining an EDCA TXOP) with the following exception, each time that the STA switches to the NPCA backup primary channel, it shall initialize CW_NPCA[AC] to a to be determined value and randomly choose a new initial value between 0 and CW_NPCA[AC] for the backoff counter (e.g., BO_NPCA[AC]).

In at least one embodiment, the non-AP channel access defer duration 932 can indicate a duration of time channel sensing is performed on the backup primacy channel before initiating count down of an EDCA back-off counter. In at least one embodiment, the defer duration can be indicated in units of microseconds (μs), in transmit units (TUs), or in a time synchronization function (TSF). In some embodiments, the non-AP channel access defer duration 932 can indicate a duration of time (e.g., as measured from a time when an NPCA switch from a primary channel to a backup primary channel is performed due to a status of the primary channel) after which associated STAs are allowed to contend for channel access on the backup primary channel. In some embodiments, this duration can enable the AP to have preferential channel access (e.g., before the STAs are allowed to contend). In at least one embodiment, this duration can be indicated in units of microseconds (μs), in transmit units (TUs), or in a time synchronization function (TSF).

In one embodiment, the ED threshold 934 can indicate an ED threshold utilized for channel idle state detection on the backup primary channel. In some embodiments, the ED threshold 934 can be measured in units of dBm/20 MHz.

In at least one embodiment, transmission mode 936 indicates types of channel access allowed on the backup primary channel. For example, the transmission mode 936 can indicate all or a subset of channel access by the AP for downlink transmission, channel access by the AP for triggered uplink transmissions, channel access by non-AP STAs for uplink transmissions, channel access by non-AP STAs for peer-to-peer (P2P) transmissions, etc.

In at least one embodiment, the signaling and information described herein with reference to NPCA notification frame 900 can already have a definition within the 802.11 family of standards and is not explicitly signaled. In other embodiments, the information and signaling can be carried in broadcast frames transmitted by the AP (e.g., beacons, probe response frames, association response frames, reassociation response frames, fast initial link setup (FILS) discovery frames, etc.

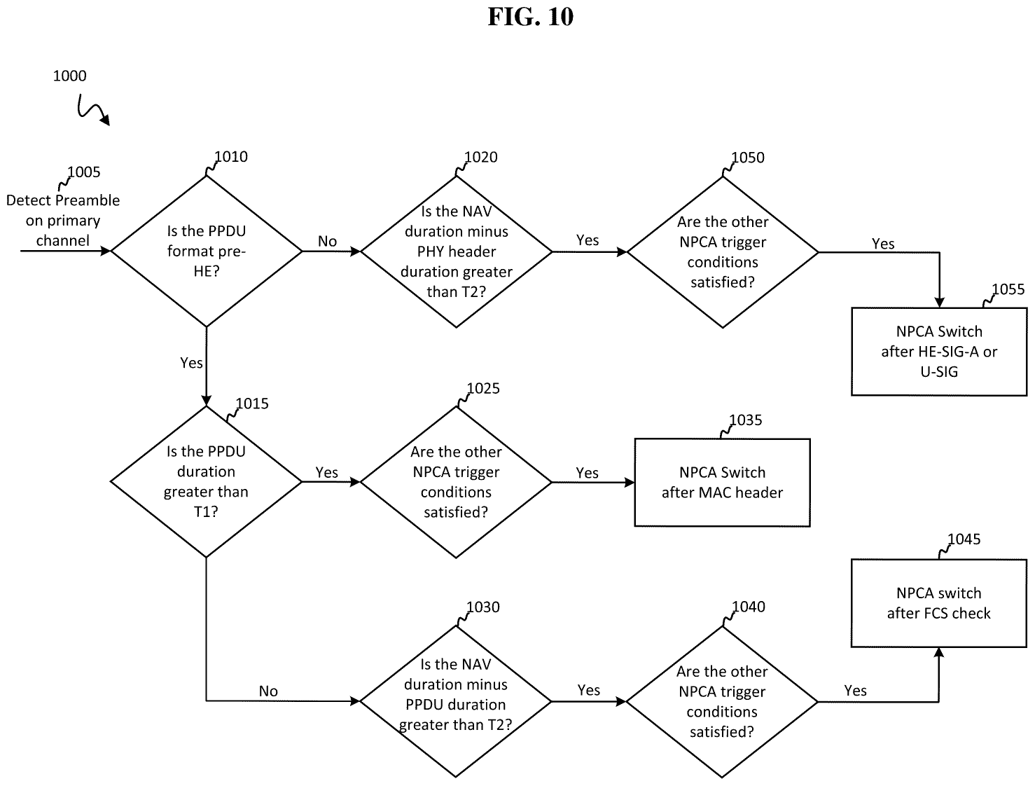

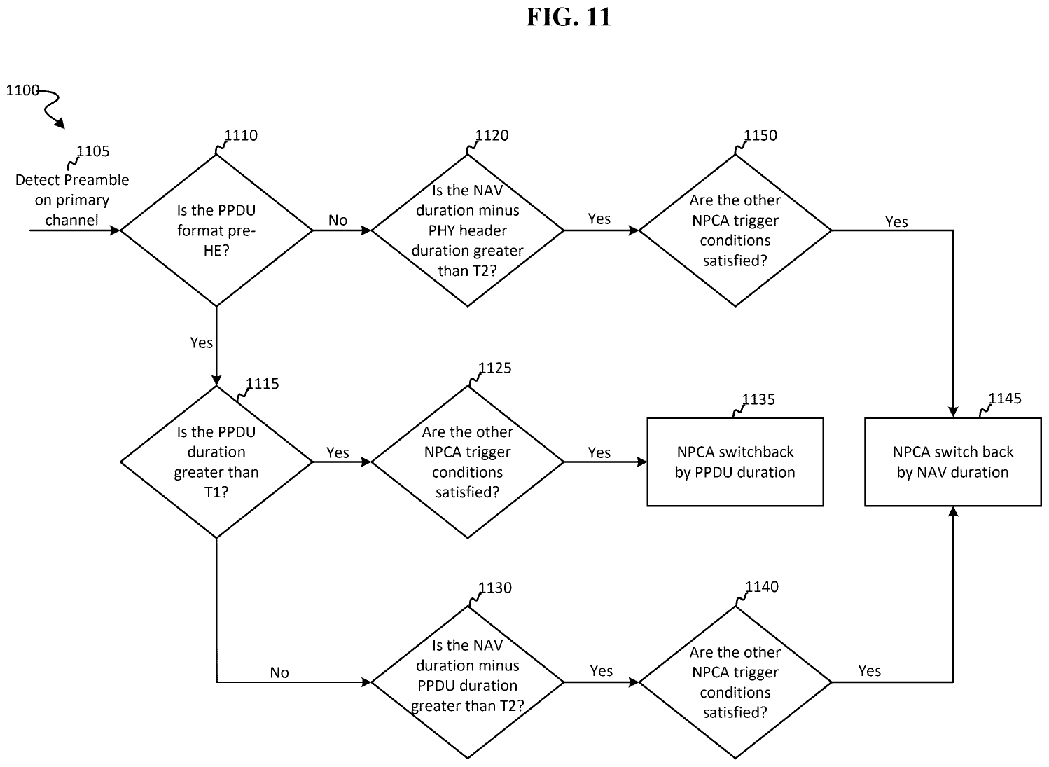

FIGS. 10 and 11 illustrate example procedures for NPCA switch time in accordance with embodiments described herein. For explanatory and illustration purposes, the process 1500 may be performed by an AP. In other embodiments, the process described herein can be performed by an STA. Although one or more operations are described or shown in a particular sequential order, in other embodiments the operations may be rearranged in a different order, which may include performance of multiple operations in at least partially overlapping time periods.

In at least one embodiment, after determining that an observed physical layer protocol data unit (PPDU) on a primary channel is eligible to trigger NPCA channel switch, NPCA supporting APs and STAs can follow a process or a set of rules defined by the 802.11 family of standards for the NPCA operation. That is, the AP or STA can perform a switch to backup primary channels for an NPCA duration and switch back at a time dictated by the process or the 802.11 family of standards.

In some embodiments, the AP or STA can perform a NPCA switch and a switch back operation (e.g., determine a switch time or NPCA duration) based on one or more of the following parameters of the overlapping basic service set (OBSS) PPDU occupying the primary channel: a physical layer (PHY) format of the OBSS PPDU (e.g., a non-high throughout (HT), very high throughout (VHT), high-efficiency (HE), extremely high throughput (EHT), ultra-high reliability (UHR), etc.), a duration of the OBSS PPDU (e.g., a duration of the PPDU observed on a primary channel, obtained from a legacy signal (L-SIG) field of a legacy PHY header), a network allocation vector (NAV) time set by the OBSS PDDU (e.g., for pre-11az PPDUs, this indication can be obtained from the TXOP subfield of a high efficiency signal (HE-SIG-A2) or universal signal (U-SIG1) field of the PHY header, a type of the OBBS PPDU (e.g., a control frame like request to sender (RTS), clear to send (CTS), multi-user RTS frames, data frames, or management frames). In one embodiment, if the STA switches from the BSS primary channel to the NPCA primary channel based on meeting a condition of the 802 family of standards, the STA shall initiate the switch at the NPCA HE switch time and it shall be ready to transmit and receive frame (subject to its capabilities and operating mode) on the NPCA primary channel no later than the value of its most recently indicated NPCA switch delay after the NPCA HE switch time. In other embodiments, if the STA switches from the BSS primary channel to the NPCA primary channel based on meeting condition 2 of 37.11 of P802.11bnD0.2, the STA shall initiate the switch at the NPCA NHT switch time and it shall be ready to transmit and receive frames addressed to it (subject to its capabilities and operating mode) on the NPCA primary channel no later than the value of its most recently indicated NPCA switching delay after the NPCA NHT switch time.

In at least one embodiment, an NPCA switch timing, NPCA switchback time, or NPCA duration can indicate a maximum allowed time to remain on the primary channel. It should be noted that the AP or the TXOP winner on the backup primary channel can perform transmissions in a shorter duration and subsequently cause STAs of the BSS to return to the primary channel before the NPCA duration elapses. In some embodiments, if multiple conditions are satisfied, a priority of the conditions can be defined in the 802.11 family of standards. In at least one embodiment, a PPDU duration can be greater than a first Time (T1). In one embodiment, the PPDU duration greater than the first time can be skipped from the NPCA process where the first time is infinite.

Referring to FIG. 10, the process 1000 may being in operation 1005. In operation 1005, the AP detects preamble on a primary channel—e.g., the STA can determine whether the primary channel is busy using a clear channel assessment (CCA). In at least one embodiment, the AP can determine to utilize NPCA operations based on determining the primary channel is busy—e.g., based on detecting the preamble on the primary channel.

At operation 1010, the STA determines if the OBSS PDDU format is pre-HE or not. In some embodiments, a pre-HE format can refer to a non-HT, HT, or VHT format. In some embodiments, the STA can determine the OBSS PPDU format is pre-HE and proceed to operation 1015. In other embodiments, the STA can determine the OBSS PPDU format is not pre-HE and proceed to operation 1020.

At operation 1015, the STA can determine if the OBSS PPDU has a duration greater than a first threshold or not. In at least one embodiment, the OBSS PPDU duration is indicated in a L-SIG field of the PHY header. In some embodiments, the STA can determine the OBSS PPDU duration is greater than the first threshold and proceed to operation 1025. In other embodiments, the STA can determine the OBSS PPDU duration is shorter than the first threshold and proceed to operation 1030.

At operation 1025, the STA can determine if other NPCA trigger conditions are satisfied. In at least one embodiment, if the STA determines the other NPCA trigger conditions are not satisfied, the STA can refrain from performing an NPCA switch. In other embodiments, the STA can determine the NPCA trigger conditions are met and proceed to operation 1035.

At operation 1035, the STA can perform an NPCA switch after an end of a specific field of a medium access control (MAC) header. That is, if an OBSS PPDU has a duration above the threshold and the OBSS PPDU is transmitted in a pre-HE format, then a switch to the backup primary channel can be performed at a predetermined fixed duration after the specific MAC field of the MAC header. In one embodiment, the specific field is an address four ‘4’ field or an HT control field and the predetermined duration is zero ‘0’ or a short inter-frame space (SIFS) interval. In at least one embodiment, the NPCA duration or the NPCA switch back time can be set such that return to the primary channel occurs at or before an end of the OBSS PPDU on the primary channel.

In embodiments, the STA determines the PPDU duration is not greater than the first threshold and proceeds to operation 1030, the STA determines if the NAV duration minus the PPDU duration is greater than a second threshold. In at least one embodiment, the STA determines the NAV duration minus the PPDU duration is greater than the second threshold and proceeds to operation 1040. In other embodiments, the STA determines the NAV duration minus the PPDU duration is not greater than the second threshold and refrains from performing the NAV switch back operation. In some embodiments, the STA can determine if the NAV time (e.g., as indicted in a duration field of the MAC header) is above the second threshold—e.g., the STA at operation 1030 evaluates only if the NAV duration or NAV time is greater than the second threshold.

At operation 1040, the STA determines if the other NPCA trigger conditions are satisfied or not. In at least one embodiment, if the STA determines the other NPCA trigger conditions are not satisfied, the STA can refrain from performing an NPCA switch. In other embodiments, the STA can determine the NPCA trigger conditions are met and proceed to operation 1045.

At operation 1045, the STA can perform an NPCA switch after a frame check sequence (FCS) check. That is, if the OBSS PPDU is either an initial control frame or has a pre-HE format, has a PPDU duration shorter than the first threshold, and the NAV duration minus the PPDU duration is greater than the second threshold, then the switch to the backup primary channel can be performed after the end of the PPDU after validating the FCS. In at least one embodiment, the STA can perform the switch back at a predetermined time after the FCS. In one embodiment, the predetermined time is a fixed duration after the end of a normal frame reception indication (e.g., PHY-RXEND.indication) belonging to the OBSS PPDU—e.g., a SIFS time interval. In at least one embodiment, the STA can perform the switch back such that the return to the primary channel is at or before the NAV time set by the OBSS transmission.

In at least one embodiment, the OBSS PPDU received is an RTS frame or another initial control frame such as an MU-RTS frame or BSRP frame. In such embodiments, the STA can perform an NPCA switch if an indication of a start of a frame reception (e.g., PHY-RXSTART.indication) is received at the STA within a NAV timeout period (e.g., NAVTimeout period) starting when the MAC receives an end of a normal frame reception indication (e.g. PHY-RXEND.indication) corresponding to the detection of the frame. Additionally, in such embodiments, a time of the NPCA switch can be at a time of reception of the indication of the start of the frame (PHY-RXSTART.indication primitive) or upon a detection of a MAC header of the frame that generated the PHY-RXSTART.indication primitive.

In at least one embodiment, the STA can perform the NPCA switch after an end of a reception of the response frame to the initial control frame. In some examples, the STA can perform the NPCA switch after a successful FCS check on the response. In other examples, the STA can perform the NPCA switch after a correct reception of the PHY header—e.g., correct reception by itself is sufficient for the STA to perform the NPCA switch. In at least one embodiment, the STA can perform the NPCA switch after the reception of the PHY preamble of the first frame that follows the initial control frame and its control frame response. In some examples, the NPCA switch can be performed a fixed duration after the start of reception indication (e.g., PHY-RXSTART.indication) of this frame, or a fixed duration after the reception of the PHY header of this frame.

In embodiments the STA determines the PPDU format is not pre-HE and proceeds to operation 1020, the STA can determine, in operation 1020, if the NAV duration minus the PHY header duration is greater than second threshold or not. In some embodiments, the STA can determine the NAV duration minus the PHY header is shorter than the second threshold. In such embodiments, the AP can refrain from performing the NPCA switch back. In other embodiments, the STA can determine the NAV duration minus the PHY header is greater than the second threshold. In such embodiments, the STA can proceed to operation 1050.

At operation 1050, the STA can determine if the other NPCA trigger conditions are satisfied. In at least one embodiment, the STA can determine the other NPCA trigger conditions are met and proceed to operation 1055. In other embodiments, the STA can determine the NPCA trigger conditions are not met and refrain from performing the NPCA switch.

At operation 1050, the STA can perform an NPCA switch after a HE-SIG-A or a U-SIG. That is, if the OBSS PPDU has an HE format (e.g., 802.11ax) and the NAV duration (e.g., as indicated in a transmission opportunity (TXOP) subfield of the HE-SIG-A2 field) minus the PHY header is greater than the second threshold, than the STA can perform the NPCA switch to the backup primary channel after a predetermined fixed duration following an end of the HE-SIG-A2 field. In one embodiment, the predetermined fixed duration is zero ‘0’ or the SIFS interval. In other embodiments, if the OBSS PPDU is a format beyond HE (e.g., 802.11be or beyond), and if the NAV duration (e.g., as indicated in the TXOP subfield of the U-SIG field) minus the PHY header is above a second threshold, then the STA can perform an NPCA switch to the backup primary channel at a predetermined fixed duration after an end of the U-SIG. In such embodiments, the predetermined fixed duration can be zero ‘0’ or the SIFS interval. In at least one embodiment, the STA can set the NPCA duration or NPCA switch back time such that the return to the primary channel is at or before the end of the NAV time set by the OBSS transmission.

Referring to FIG. 11, the process 1100 may being in operation 1105. In operation 1105, the AP detects preamble on a primary channel—e.g., the STA can determine whether the primary channel is busy using a clear channel assessment (CCA). In at least one embodiment, the AP can determine to utilize NPCA operations based on determining the primary channel is busy—e.g., based on detecting the preamble on the primary channel. In at least one embodiment, Operations 1110, 1115, 1120, 1125, 1130, 1140, and 1150 are the same or similar to operations 1010, 1015, 1020, 1025, 1030, 1040, and 1050 as described with reference to FIG. 10. Accordingly, the corresponding description is omitted for clarity.

In one embodiment, FIG. 11 can illustrate an example where the NPCA switch back time is either based on the NAV duration or the PPDU duration. For example, if the STA determines the other NPCA trigger conditions are satisfied at either operation 1140 or 1150, the STA can proceed operation 1145—e.g., if the OBSS PPDU format is not pre-HE and the NAV duration minus the PHY header is greater than the second threshold or the OBSS PPDU format is pre-HE, the PPDU duration is shorter than the first threshold, and the NAV duration minus the PPDU duration is greater than the second threshold. In other embodiments, if the PPDU format is pre-HE but the PPDU duration is greater than the first threshold, the STA can proceed to operation 1135 if the other NPCA trigger conditions are satisfied in operation 1125.

At operation 1145, the STA can perform an NPCA switch back by an end of the NAV duration (e.g., indicated in the TXOP field of the U-SIG or the HE-SIG-A2 fields).

At operation 1135, the STA can perform an NPCA switch back by an end of a PPDU duration (e.g., as indicated in the PHY header).

In at least one embodiment, instead of directly imposing the rule on the switch time of all devices in the BSS, the 802.11 family of standards may define aforementioned rules for the switch time of the AP or STA. In such embodiments, the AP is expected to be capable of reception on the backup primary channel after the defined switch time in light of any applicable additional NPCA channel switching delays indicated. In some embodiments, non-AP STAs intending to transmit to the AP can contend for channel access after the expected time when the AP is capable of reception, subject to further non-AP STA deferral periods indicated by the AP. In some embodiments, a non-AP STA that performs a switch earlier can exploit time till the AP is expected to be capable of reception to satisfy any medium synchronization requirements applicable for channel access on the backup primary channel. Additionally, there may be channel switch rules to dictate whether or not for a specific type of OBSS frame, the switch to the backup primary channel is performed by the AP or one or more STAs.

In some embodiments, the AP can also indicate periodic service periods during which the switch of the primary channel to the backup primary channel can take place, independent of an occupancy of the primary channel. In such embodiments, the NPCA supporting STAs and the AP may perform the switch to the backup primary channel at the start time of the service period.

In at least one embodiment, a NAV duration (e.g., as referenced in FIG. 10 and FIG. 11) refers to a NAV duration indicate in a PPDU and counted from a beginning of the PPDU—e.g., the NAV duration included the PPDU duration. In some embodiments, the NAV duration can refer to a NAV duration indicated in a PPDU that is counted from the end time of the PPDU. In such examples, the operations in FIGS. 10 and 11 may be slightly modified. For example, if the NAV duration is calculated at the end of the PPDU, then the STA or AP can determine if the NAV duration plus the PPDU duration minus the PHY header duration is greater than the second threshold and NAV duration is greater than the second threshold as replacements for ‘NAV duration minus PHY header duration is greater than the second threshold’ and ‘NAV duration minus PPDU duration is greater than the second threshold,’ respectively.

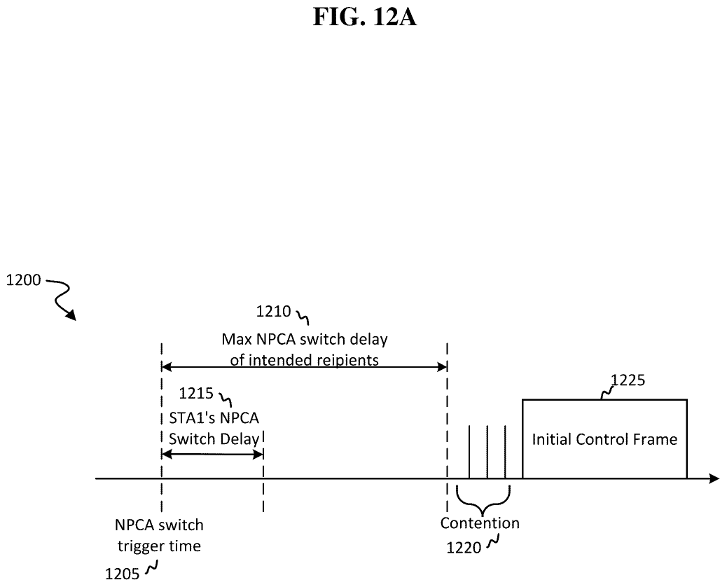

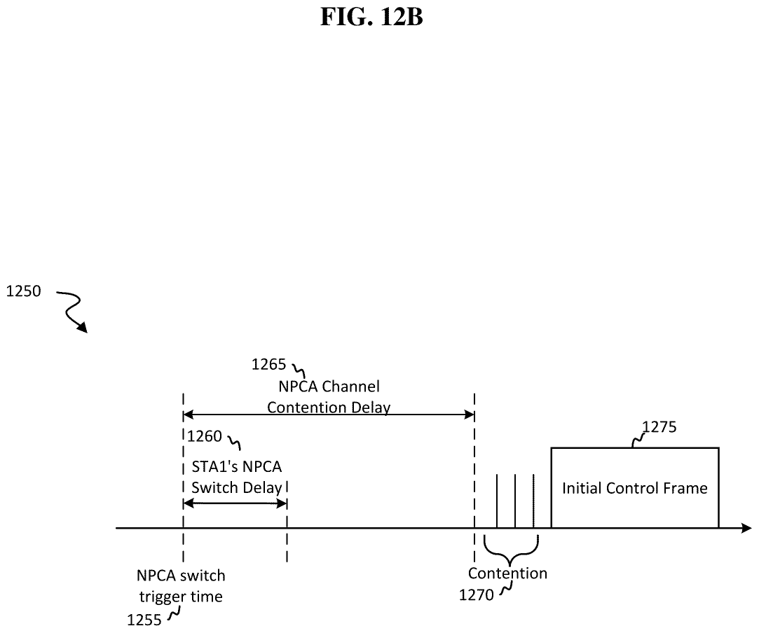

In one embodiment, FIGS. 12a-14 illustrate channel access procedures on the backup channel (e.g. the NPCA primary channel). In at least one embodiment, rules for NAV synchronization can be applicable to NPCA supporting STAs of the BSS for channel access on the backup primary channel after performing the switch. In at least one embodiment, rules for medium synchronization delay can be applicable to NPCA supporting STAs of the BSS for channel access on the backup primary channel after performing the switch. In some embodiments, independent of these synchronization rules, there can be additional delays the AP or STA can perform during NPCA operations.

For example, for NPCA operations, there can be a fixed defer interval during which the AP and STAs of the BSS observe a medium before performing the channel contention on the back-up channel. In some embodiments, the defer interval is an example of a fixed value such as the DIFS interval, or an AISFN interval (e.g., based on access categories), or the defer interval can be indicated by the AP in an NPCA control element. In at least one embodiment, the start of the defer interval can be from a time that the STA is capable of preamble detection on the backup primary channel. In at least one embodiment, the start of the defer interval can be counted from the time of initiating the NPCA switch by the STA.

In at least one embodiment, devices of the NPCA AP's BSS can begin contention on the NPCA backup primary channel only after the defer interval indicated by the AP or fixed by the 802.11 family of standards. In at least one embodiment, the defer interval is counted from a time of trigger the NPCA switch. In at least one embodiment, the defer interval can handle a case of fairness between multiple BSSs participating in NPCA operations where each BSS may have a different NPCA switch delay. In at least one embodiment, neighboring APs participating in an NPCA operation can negotiate a common defer interval to be used by them. In some embodiments, an NPCA STA can have multiple defer intervals applicable. In such embodiments, the STA can initiate contention after all of the defer intervals have passed (e.g., based on a longest defer interval). For example, if an NPCA STA initiates an NPCA switch at time t₁ and is capable of contention at time t₂ on the NPCA primary channel, and the STA has defer intervals 41 and 42 applicable from the two times, respectively, then the STA can start the contention at or after a maximum of {t₁+Δ₁,t₂+Δ₂}. For example, if t₂+Δ₂ is larger than t₁+Δ₁, the STA can perform contention at the time t₂+Δ₂ or later.

In at least one embodiment, some STAs associated with an NPCA operation can retain a last NPCA back-off counter value (e.g., the NPCA back-off counter value from a previous NPCA switch) and reuse the last NPCA back-off counter value for a next NPCA switch—e.g., can reuse after the next NPCA switch. In some embodiments, the STAs can be examples of APs—e.g., the NPCA switch can be performed by either the STA or the AP.

In at least one embodiment, STAs that successfully performed NPCA transmission in a previous NPCA switch attempt can utilize a larger contention window, a larger back off counter value, or utilize a larger defer duration to initiate NPCA transmissions in a next A NPCA switch event where A is defined by the 802.11 family of standards or negotiated between neighboring APs and announced by each AP. In other embodiments, an NPCA STA can have a TXOP limit on a TXOP size of a first TXOP initiated by the NPCA STA after switching to an NPCA primary backup channel. In at least some embodiments, the AP or the 802.11 family of standards can specify the TXOP limit. In at least one embodiment, the TXOP limit applies to the first TXOP and not the remaining TXOP—e.g., TXOPs initiated later within the same NPCA switch event or operation may not be associated with the TXOP limit. In other embodiments, all or a subset of STAs participating in an NPCA operation may be specified a minimum NPCA switch duration and/or an NPCA switchback duration by the 802.11 family of standards. In some embodiments, the subset of STAs can be NPCA APs, for example.

In some embodiments, only the AP can contend for channel access on the NPCA primary channel. That is, the transmission are either downlink or trigger-based uplink transmissions. In some examples, an NPCA AP can enable a mode of operation in which untriggered uplink (UL) transmissions on the NPCA primary channel by NPCA non-AP STAs is not permitted. The mode can be for all associated non-APs or per non-AP. In some embodiments, multi-user (MU) enhanced distribution channel access (EDCA) parameters are used for this mode. In other embodiments, the MU EDCA parameters are not used for this mode.

In another embodiment, both the AP and non-AP STAs can contend to win channel access on the backup primary channel. In some embodiments, some non-AP STAs nominated by the AP or non-AP STAs that satisfy certain rules or conditions can participate in the channel contention—e.g., other non-AP STAs are excluded. In at least one embodiment, the AP or the rules/conditions can select the subset of non-AP STAs to minimize a chance of collision on the NPCA backup primary channel. For example, non-AP STAs that qualify as having low latency traffic can participate in the contention while other non-AP STAs cannot. In one or more embodiments, the non-AP STAs apply an additional deferral period that starts from an expected start time of when the AP is capable of reception in order to provide preferential channel access to the AP (e.g., during the additional deferral period).

In one embodiment, channel bonding is limited to contain only the channels lying within an operating bandwidth disclosed by the AP for its BSS in an operating element when accessing the channel on the backup primary channel. That is, when an NPCA STA switches to the NPCA primary channel for the NPCA operation, the 20 MHz channels occupied by PPDUs transmitted by the STA shall all meet at least all of the following conditions, i) include at least the NPCA primary channel and ii) all be within the BSS bandwidth. In another embodiment, the AP can disclose an NPCA operating bandwidth to indicate the channels over which channel bonding can be performed.

In some examples, the AP can initiate a transmission on the backup primary channel using a request to send (RTS) clear to send (CTS) exchange and/or by transmitting a CTS-to-self frame. In at least one embodiment, the AP can also initiate the transmission on the backup primary channel transmitting an initial control frame (ICF) defined for NPCA operation (e.g., a MU-RTS trigger frame, a buffer status report poll (BSRP) trigger frame, or a new variant of a trigger frame). That is, when the NPCA STA switches to the NPCA primary channel for NPCA operation, then at least the following rule applies, the STA shall begin all frame exchanges on the NPCA primary channel with an NPCA initial control frame using non-HT PPDU or non-HT duplicate PPDU format using a rate of 6 megabits per second (Mb/s), 12 Mb/s, or 24 Mb/s.

In one embodiment, the AP can indicate certain parameters regarding the channel access on the backup primary channel in the initial control frame or trigger frame transmitted. In at least one embodiment, the parameters regarding access on the backup primary channel includes at least one of the following: an indication that the frame is being transmitted on the NPCA primary channel, an NPCA duration (e.g., as indicated by setting a NAV duration in the MAC or PHY header, or indicated by a separate field in the frame), an indication of whether a NAV-duration based on PPDU-duration based NPCA operation is being performed, an indication of parameters of the OBSS PPDU occupying the primary channel (e.g., including BSS color, transmit address, receive address, bandwidth, PPDU type, NAV duration, PPDU duration, etc.), an NPCA switch back time, available sub-bands for performing channel bonding during the NPCA duration, an energy detection (ED) threshold to se for channel access on the backup primary channel for the NPCA duration, EDCA parameters to be used by the STAs on the backup primary channel for the NPCA duration, a number of retransmissions allowed upon failed first transmission on the backup primary channel during the NPCA duration, or a list of STAs that are allowed to contend for channel access on the NPCA backup channel for the NPCA duration. In at least one embodiment, the parameters described herein can be examples of parameters included in the NPCA notification frame. In such embodiments, the most recent parameters indicated in the initial control frame or trigger frame can temporarily rewrite the NPCA notification frame parameters for the NPCA duration.

In at least one embodiment, the AP can schedule STAs on the backup primary channel that the AP is aware have switched to the NPCA backup channel based on the STA indications of the NPCA operation and the rules of channel switch indicated by the STAs. In order to acquire the requisite information, the AP can transmit a trigger frame (e.g., a MU-RTS, BSRP, or a bandwidth query report poll (BQRP) frame) to solicit feedback from the STAs to confirm their availability on the backup primary channel before the AP proceeds to schedule traffic to and from them. That is, when the NPCA STA switches to the NPCA primary channel for NPCA operation, then at least the following rule applies: the STA shall not initiate a transmission on the NPCA primary channel to another STA until that STA's NPCA switching delay time has elapsed since the NPCA HE switch time if switching due to a first condition or NPCA NHT switch time if switching due to a second condition of the 802 family of standards

In at one embodiment, a non-AP STA initiating channel contention on the NPCA backup primary channel can initiate a frame exchange with an initial control frame (ICF) that solicits a response (e.g., an initial control response (ICR) frame) from the AP. In some embodiments, the non-AP STA can set the NAV duration to be a small value that is sufficient to obtain a response frame from the AP. For example, the NAV duration can be predetermined by the 802.11 family of standards.

In one embodiment, the AP can indicate a duration for which its available on the NPCA backup primary channel in a field of the response frame—e.g., the response frame can include a field the AP sets. In some embodiments, based on the indication, in a subsequent transmission by the non-AP STA after receiving the response frame, the non-AP STA can update the NAV time for the TXOP while ensuring it is smaller than a duration for which the AP is available on the NPCA primary channel. In at least one embodiment, if the non-AP initiates a transmission with the AP and the NAV time set is longer than the duration for which the AP remains on the NPCA backup primary channel, then either the AP refrains from responding to the non-AP STA's frame, the AP indicates in the response frame that the AP will be unavailable for at least a portion of the TXOP duration, or the AP transmits an unavailability duration indication in the response frame to the non-AP STA, where the unavailability duration includes an unavailability start time determined based on the time when the AP needs to return to the primary channel

In one embodiment, when the NPCA STA performs a switch to the NPCA primary channel and initiates channel contention, the STA can select a backoff counter between zero ‘0’ and a fixed maximum contention window value (e.g., CWₘₐₓ). In another embodiment, the NPCA STA can select the backoff counter between zero ‘0’ and an existing contention window size the STA was utilizing on the primary channel. That is, in some embodiments, the same contention size window is used for both the primary channel and the backup primary channel. In some embodiments, the contention windows are a function of an access category (AC) for which the contention is initiated.

In some embodiments, the NPCA STA can detect a collision during contention on the backup primary channel. In such embodiments, the NPCA STA can increment the contention window size compared to a contention window size used on the NPCA backup primary channel before detecting the collision. In at least one embodiment, the NPCA STA can refrain from incrementing the contention window size even after detecting a collision.

In some embodiments, after the NPCA operation, when the NPCA STA performs a switch back from the NPCA backup primary channel to the primary channel and the NPCA STA initiates contention, the NPCA STA can select a backoff counter between zero ‘0’ and a fixed maximum contention window value (e.g., CWₘᵢₙ or CWₘₐₓ). In at least one embodiment, the NPCA STA can retain (e.g., save) a contention window the NPCA STA was utilizing on the primary channel before performing the NPCA switch to the backup primary channel. In such embodiments, the NPCA STA can select a backoff counter value between zero ‘0’ and the saved contention window value when the NPCA STA performs channel contention on the primary channel after the NPCA switch back operation. In other embodiments, the NPCA STA saves the backoff counter the NPCA STA was utilizing on the primary channel before performing the NPCA switch to the backup primary channel. In such embodiments, the NPCA STA can reuse the same backoff counter when initiating the channel contention on the primary channel after performing the NPCA switch back operation—e.g., unless there is no saved backoff counter value for a specific access category being accessed. In at least one embodiment, if there is no saved backoff counter, the NPCA STA can select a backoff counter based on the contention window size. In at least one embodiment, the NPCA STA can select a backoff counter between zero ‘0’ and an existing contention window size the STA was utilizing in the NPCA backup primary channel. In such embodiments, the NPCA STA utilizes the same contention window size on the primary channel and the backup primary channel. In at least one embodiment, the contention windows are a function of the access categories for which the contention is initiated.

Referring to FIG. 12A, an NPCA STA can perform a switch to the NPCA backup primary channel after experiencing an NPCA trigger event. In one embodiment, each NPCA STA that is allowed to contend on the NPCA backup primary channel can initiate contention independently after the respective NPCA STA has completed the NPCA switch, subject to any further deferrals—e.g., deferrals such as a 802.11 standard defined contention delay to meet medium synchronization requirements or a deferral to ensure the intended recipients of the transmission have also completed the NPCA switch.

For example, NPCA operation 1200 can illustrate that when a first NPCA STA (e.g., which can be either an AP or non-AP) performs an NPCA switch after an NPCA trigger condition, the first NPCA STA can transmit an initial control frame (ICF) 1225 (e.g., or other frames) to one or more peer NPCA STAs to initiate transmission with them. In such embodiments, the first NPCA STA can start contending for channel access to transmit the ICF 1225 or other frame at a time when all intended recipients of the ICF 1225 have completed the NPCA switch or at a fixed offset from that time. For example, the first NPCA STA and the intended recipients of the ICF 1225 (e.g., the peer NPCA STAs) can have an NPCA switch trigger time 1205. In one embodiment, the first NPCA and the per NPCA STAs can begin to switch to the NPCA backup primary channel at the NPCA switch trigger time 1205. In some embodiments, different NPCA STAs can have different NPCA switch delays—e.g., an amount of time for an NPCA STA to switch to the NPCA backup primary channel can vary from NPCA STA to NPCA STA. For example, the first NPCA STA can have a switch delay 1215—e.g., the first NPCA STA completes the switch to the NPCA backup primary channel at the end of the first STA's switch delay 1215. After completing the switch, the first NPCA STA can wait to contend until all recipients of the ICF 1225 have also made the switch. In one embodiment, the first STA can wait a max NPCA switch delay of intended recipients' duration 1210—e.g., a maximum duration needed for any NPCA STA that is receiving the ICF 1225 from the first NPCA STA. In at least one embodiment, the first NPCA STA can perform contention 1220 on the channel following the elapse of the max NPCA switch delay of intended recipients' duration 1210 (e.g., after all of the intended recipients have made the switch to the NPCA backup primary channel). After performing the contention, the first NPCA STA can transmit the ICF 1225 to the intended recipients.

In at least one embodiment, the first STAs NPCA switch delay 1215 can be an example of an NPCA switching delay. That is, the STA can transmit the NPCA switch delay 1215 in an NPCA switching delay field that indicates a time needed by an NPCA STA to switch from the BSS primary channel to the NPCA primary channel in units of 4 μs. In at least one embodiment, the first STA delay in switching back to the primary channel can be referred to as a NPCA switch back delay. That is, the STA can transmit the NPCA switch back delay in an NPCA switch back delay field that indicates a time needed by an NPCA STA to switch from the NPCA primary channel to the BSS primary channel in units of 4 μs. In at least one embodiment, the STA can also transmit an NPCA primary channel (e.g., in an NPCA primary channel field to indicate a channel number of a channel within the BSS bandwidth that corresponds to the channel that the NPCA AP and its associated NPCA non-AP STAs switch to in order to perform the NPCA operation) and an NPCA minimum duration threshold (e.g., in an NPCA minimum duration threshold field that indicates a minimum duration of inter-BSS activity (inter BSS PPDU or inter-BSS TXOP) that is required to have been indicated on the primary channel of the BSS as a necessary condition to permit an NPCA STA to switch to the NPCA primary channel to perform NPCA operations. In at least one embodiment, the STA can transmit the above mentioned information in an NPCA operation information field format present in an UHR operation field.

Referring to FIG. 12B and NPCA operation 1250, in some examples, there is a fixed delay from an NPCA switch trigger time 1255 to a time when the channel contention 1270 can be initiated on the backup primary channel. That is, to synchronize the NPCA contention on the backup primary channel, there can be a delay defined by the 802.11 family of standards or indicated by the AP when enabling the NPCA operation. In one embodiment, the fixed delay is referred to as an NPCA channel contention delay 1265. In other embodiments, the delay can be referred to as something other than NPCA channel contention delay.

In at least one embodiment, the AP can indicate the NPCA channel contention delay 1265 in a capabilities element transmitted by the AP or in a UHR operation element transmitted by the AP in some unicast or broadcast frame. In one embodiment, a first NPCA STA and intended recipients of an initial control frame (ICF) 1275 can have an NPCA switch trigger time 1255. In such embodiments, the first NPCA STA can perform channel contention 1270 after the first NPCA STA has completed the switch to the NPCA backup primary channel and the NPCA channel contention delay 1265 has elapsed. After the contention 1270, the first NPCA STA can transmit the ICF 1275 to the intended recipients. In at least one embodiment, the NPCA channel contention delay 1265 is observed from the NPCA switch trigger time 1255—e.g., the NPCA channel contention delay 1265 starts from the NPCA switch trigger time 1255.

In order to perform the contention 1270, the first NPCA STA can also satisfy additional requirements. For example, the first NPCA STA can participate in the contention 1270 if the first NPCA STA switch delay 1260 is shorter than the NPCA channel contention delay 1265 and the first NPCA STA has non-zero buffered traffic available for transmission. In at least one embodiment, if the first NPCA STA wins a TXOP opportunity, the initial ICF 1275 by the first NPCA STA can be addressed to recipients whose NPCA switch delay is less than the NPCA channel contention delay 1265. In such embodiments, NPCA STAs that have a longer switch delay than the NPCA channel contention delay 1265 can be served later within the TXOP. In one embodiment, for some modes of the NPCA operation, the NPCA channel contention delay 1265 can apply to non-AP STAs participating in the NPCA operation but not to the AP.

In one embodiment, the first NPCA STA can initiate a channel contention 1270 before an end of the NPCA channel contention delay 1265 if the recipient NPCA STA also has a shorter NPCA switch delay than the NPCA channel contention delay 1265—e.g., both the first NPCA STA and the recipient NPCA STA are switched to the backup primary channel before the end of the NPCA channel contention delay 1265. In such embodiments, the first NPCA STA can transmit the ICF 1275 (e.g., the transmission of the ICF 1275 can be delayed until) based on either of the following two conditions being met: all intended recipients of the ICF 1275 have completed the NPCA switch operation, the maximum NPCA switch delay has elapsed as counted from the NPCA switch trigger time.

In one embodiment, the NPCA STAs can switch to the NPCA backup primary channel and start contention at an appropriate time after observing an NPCA switch trigger condition. In such embodiments, if another transmission wins the channel contention on the backup primary channel after the NPCA switch but the transmission cannot be determined to be from the same BSS, the NPCA STA can either detect the transmission and switch back to the primary channel immediately, the NPCA STA can remain on the NPCA backup primary channel until the NPCA STA's original determined NPCA switch back time, or the NPCA STA can switch back to the primary channel if a duration of the transmission is above a certain threshold and remain on the NPCA backup primary channel until the NPCA STA's originally determined NPCA switch back time if the transmission is below the certain threshold. In one embodiment, the threshold can be related to an original NPCA switch back time. In at least one embodiment an AP can indicate to the NPCA STA of which option to employ when receiving the transmission from another BSS. In one embodiment, if the NPCA STA remains on the NPCA backup primary channel, the NPCA STA can restart the contention on the NPCA primary channel after the observed transmission on the backup channel concludes.

In one embodiment, if an NPCA STA observes a transmission on the NPCA backup primary channel and a NAV end time set by the observed transmission is smaller than a NAV duration set by an OBSS transmission on the primary channel by a threshold value, then the NPCA STA can contend for channel access on the NPCA backup primary channel after the end of the observed transmission NAV time—e.g., the NPCA STA can determine the observed transmission will stop before the end of the NAV duration set by the OBSS transmission. In one embodiment a subset of the NPCA STAs can be eligible for contention on the NPCA backup primary channel after the end of the observed transmission. In one such embodiment, the eligible STAs can be NPCA APs. In other examples, the NPCA AP indicates a list of eligible NPCA STAs.

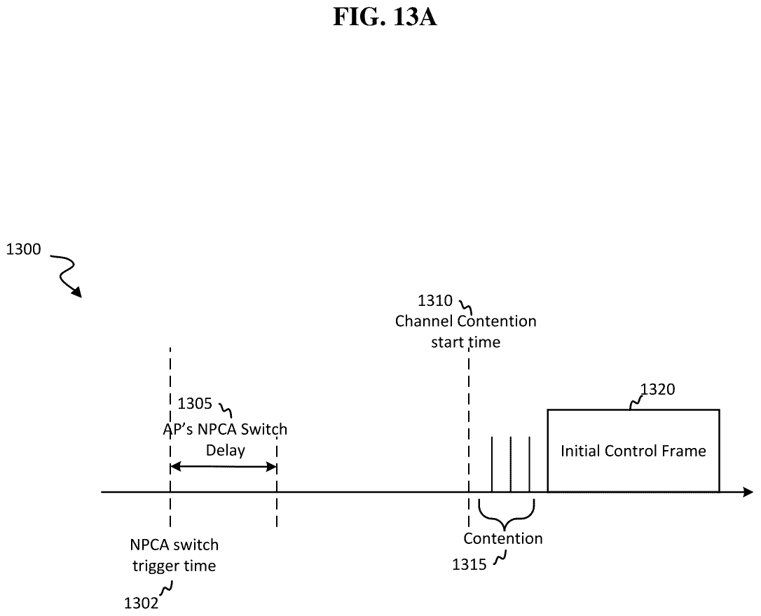

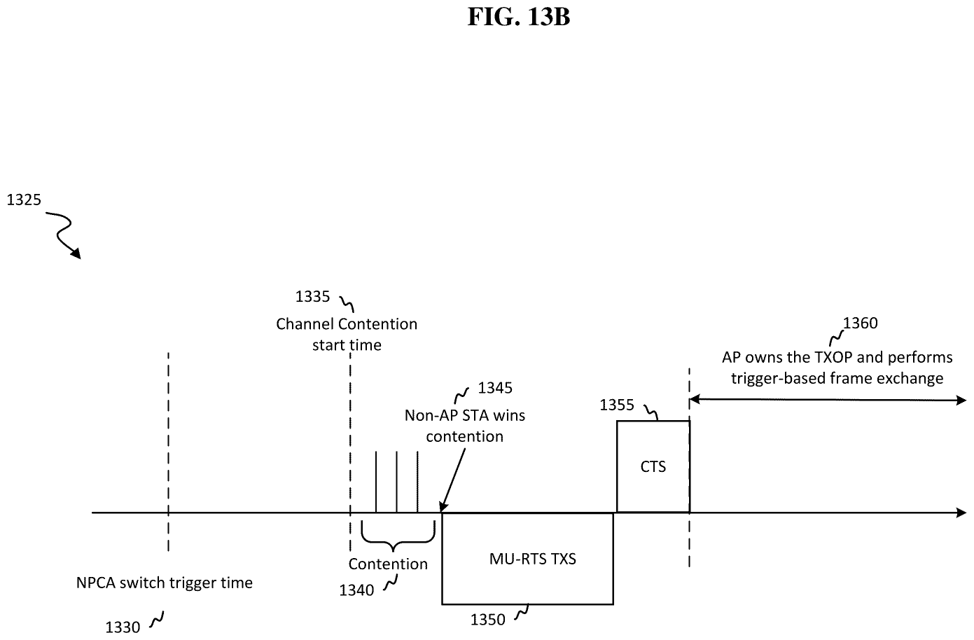

Referring to FIGS. 13A and 13B, there can be a mode of the NPCA operation during which only trigger-based transmission can be allowed on the backup channel after performing the NPCA switch. For example, FIG. 13A illustrates an NPCA operation 1300 where at an applicable channel contention start time 1310, an AP can initiate contention 1315 for the transmission, and if the AP wins the contention 1315, the AP can transmit an initial control frame (ICF) 1320 or a trigger frame to associated NPCA STAs. That is, the AP can have a NPCA switch trigger time 1302 and experience a NPCA switch delay 1305. After the time 1305, the AP can switch to the NPCA backup primary channel. However, the AP can wait to initiate the contention 1315 until after the designated channel contention start time 1310.

In at least one embodiment, non-AP STAs cannot perform channel contention after switching to the NPCA primary channel—e.g., the non-AP STAs can wait to receive a trigger frame from the AP before transmission. In at least one embodiment, the non-AP STAs can be allowed to perform channel contention but after a defer interval to give prioritized channel access to the AP. In at least one embodiment, the NPCA non-AP STAs can utilize a contention window for the channel access that is different than a contention window used by the NPCA AP for channel access. In one embodiment, the NPCA non-AP STAs can have a larger contention window than the NPCA AP. In some embodiments, non-AP STAs nominated by the AP or those non-AP STAs that satisfy certain rules can participate in the channel contention. As an example, non-AP STAs that have low latency transmission or those that have obtained NAV synchronization on the NPCA backup primary channel may participate in the channel contention.

Referring to FIG. 13B and NPCA operation 1325, in some embodiments of the trigger-only mode, any NPCA STA can also be allowed to perform channel contention at an applicable channel contention start time 1335 after making the NPCA switch. For example, if an AP wins contention, the AP can transmit an initial control frame (ICF) to NPCA STAs, and after receiving a response to the ICF, initiate trigger-based uplink or downlink transmission with the NPCA STAs—e.g., similar to FIG. 13A.

In other embodiments, a non-AP STA can win the contention 1340. For example, at NPCA switch trigger time 1330, both the AP and non-AP STAs can perform an NPCA switch. In one embodiment, those AP's and non-AP STAs that have performed the switch by the channel contention start time 1335 can begin to perform contention 1340—e.g., both AP and non-AP STAs can perform the contention 1340.

In one embodiment, a non-AP STA wins contention at 1345. In such embodiment, the non-AP STA can transmit a MU-RTS triggered TXOP sharing (TXS) trigger frame 1350 to share the TXOP with the AP. In such embodiments, the AP can own the TXOP upon reception of the MU-RTS TXS trigger frame and the AP can correspondingly initiate the trigger-based uplink or downlink transmissions with the NPCA STAs. That is, the AP can respond to the MU-RTS TXS frame 1350 with a clear to send (CTS) frame 1355, after which the AP owns the TXOP and performs the trigger-based frame exchange during operation 1360. In at least one embodiment, the non-AP STA can perform an additional initial control frame (ICF) exchange with the AP before the non-AP STA transmits the MU-RTS TXS frame 1350. In at least one embodiment, the AP can also allocate resources to the non-AP STA which won and shared the TXOP with the AP in the trigger-based transmission. In one embodiment, the non-AP STA can also transmit an additional CTS-to-self frame before transmitting the MU-RTS TXS trigger frame 1350 to the AP. In at least one embodiment, the non-AP STA can set a NAV time for the TXOP based on a maximum TXOP duration allowed for a selected access category and/or the duration after which the NPCA switch back to the primary channel is to be performed.

In one embodiment, the NPCA non-AP STAs participating in the channel access can initiate channel contention 1340 at a deferred time, where the deferred time is measured from the NPCA switch time 1330 or from the channel contention start time 1355. In at least one embodiment, the AP can indicate the deferral time to the non-AP STAs when enabling the NPCA operation. In one embodiment, a subset of the non-AP STAs is nominated by the AP or eligible for channel contention 1350 based on satisfying certain rules—e.g., not all of the non-AP STAs are allowed to perform the channel contention 1350.

In at least one embodiment, after observing a first transmission on the NPCA backup primary channel, any NPCA STA can perform a second contention and onwards. In one embodiment, this rule applies after the observation of the first transmission initiated by the serving AP on the NPCA backup primary channel, which can include the NPCA initial control frame.

In one embodiment, after the NPCA AP wins channel contention 1340 on the NPCA backup primary channel and transmits an initial control frame to reserve the medium and synchronize the devices in the AP's BSS, the AP can initiate a second contention phase for the devices within the BSS to contend and win the channel access using the EDCA procedure. In one embodiment, the second contention phase is initiated immediately or later within the TXOP. In at least one embodiment, the AP can initiate the second contention phase by transmitting a specific frame (e.g., a second contention frame). In at least one embodiment, the second contention phase EDCA parameters can be predetermined, can be the same as the EDCA parameters for contention on the primary channel, can be indicated by the AP when it enables the NCPA, or can be indicated by the AP transmitting the specific frame—e.g., the AP can include the EDCA parameters within the specific frame. In at least one embodiment, a contention procedure used for low-latency traffic after transmission of a defer signal can also be reused for the second contention window. In some embodiments, if a collision is detected during the contention 1340 (e.g., or the second contention phase), the contention phase 1340 can restart again with a same or larger contention window.

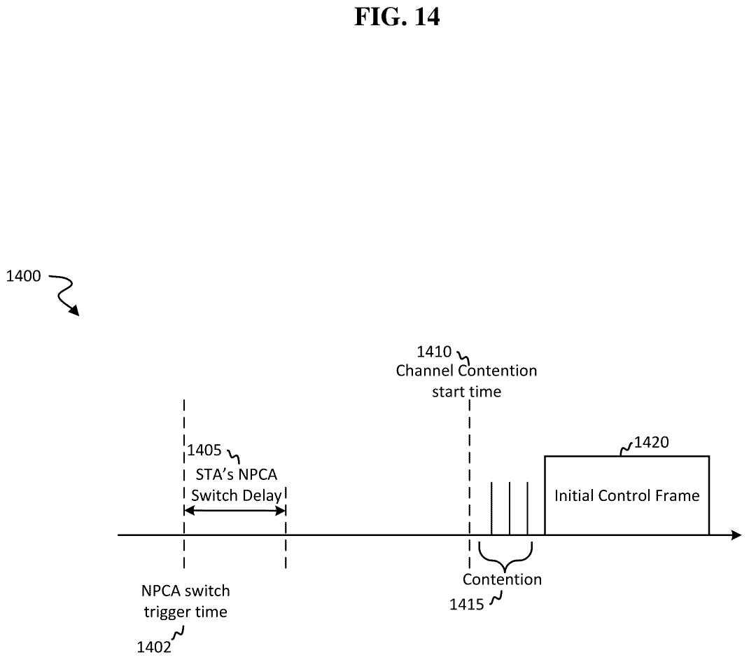

Referring to FIG. 14 and NPCA operation 1400, in some embodiments, non-trigger-based transmission are allowed on the backup primary channel after performing the NPCA switch. In such embodiments, any NPCA STA can perform channel contention 1415 at the channel contention start time 1410 following an NPCA switch—e.g., following an NPCA STA initiating an NPCA switch at NPCA switch trigger time 1402 and finishing the NPCA switch at the end of the STA's NPCA switch delay 1405.

In at least one embodiment, if any NPCA STAs (e.g., AP or non-AP) win contention, they can proceed to transmit an initial control frame (ICF) 1420 to peer NPCA STAs. In such embodiments, the NPCA STA can receive a response to the ICF 1420 and initiate transmission with the peer STAs. In one embodiment, the NPCA non-AP STAs participating in the channel access can initiate channel contention 1415 at a deferred time, where the deferred time is measured from the NPCA switch time 1330 or from the channel contention start time 1355 and indicated by the AP when enabling NPCA operations.

In at least one embodiment, the transmission on the backup primary channel can be ended to ensure that there is sufficient time to return to the primary channel before a NAV duration or PPDU duration set by the OBSS PPDU expires. In at least one embodiment, the AP can indicate an NPCA transition delay or an NPCA channel access delay or a NPCA switch back delay representing the sufficient time. In at least one embodiment, if a format of the OBSS PDDU is before HE (e.g., non-HT, HT, or VHT), then the NAV obtained from the duration field of the MAC header is used to determine the switch back time. In other embodiments, if the format of the OBSS PDDU is HE or later (e.g., HE, EHT, UHR, etc.), then the NAV duration can be obtained from the TXOP subfield of the HE-SIG-A2 or U-SIG1 field of the PHY header to determine the switch back time as described with reference to FIGS. 10 and 11. In one embodiment, if a collision is observed for an initial transmission on the backup channel, then all STAs of the BSS can return to the primary channel and refrain from further transmissions on the backup channel within the OBSS NAV duration.

In at least one embodiment, an NPCA supporting EMLSR STA can have a full receive capability after performing a switch to the backup primary channel. In other embodiments, the NPCA supporting EMLSR STA can have listening operation capabilities after performing a switch to the backup primary channel. In such embodiments, the AP can initiate transmission with the NPCA supporting EMLSR STA on the backup primary channel with an EMLSR initial control frame with applicable EMLSR padding delay.

In another embodiment, an EMLSR non-AP MLD can indicate, when enabling NPCA operations, whether the EMLSR non-AP MLD will operate in a listen state or have full capability after performing the NPCA switch. In one embodiment, this indication is carried, for example, in the frame that the EMLSR non-AP MLD transmits to indicate participation in the NPCA operation.

In some embodiments, during transmissions on the NPCA backup primary channel, an EMLSR non-AP STA can be capable transmitting or receiving transmissions on an ‘X’ MHz channel that overlaps with the NPCA backup primary channel, where ‘X’ is a full capability bandwidth of the non-AP STA. In at least one embodiment, the EMLSR non-AP STA is capable of transmission or reception on the sub-bands of the NPCA TXOP that overlap with the ‘X’ MHz channel that overlaps with the primary channel. In such embodiments, the non-AP STA can participate in the NPCA operation if the NPCA backup primary channel is part of the ‘X’ MHz channel that overlaps with the primary channel. In at least one embodiment, the EMLSR non-AP MLD can transmit an indication of the ‘X’ bandwidth capability on the NPCA backup channel in a frame the EMLSR non-AP transmits to indicate participation in the NPCA operation. In some embodiments, the non-AP STA can indicate the ‘X’ bandwidth capability in the non-AP STA capabilities element. In some embodiments, resource allocation to a non-AP STA on the NPCA backup primary channel can comply with the indicated bandwidth capability. In some embodiments, the mechanisms described herein for EMLSR non-AP STAs can also apply to other types of non-AP STAs. For example, a regular non-AP STA can also indicate the non-AP STA's bandwidth capabilities on the NPCA backup primary channel. In at least one embodiment, the non-AP STA can indicate the bandwidth capabilities in a frame transmitted to the AP to enable the NPCA operation.

In at least one embodiment, an NPCA supporting dynamic power save (DPS) STA can operate in a higher power mode after performing the switch to the backup primary channel. In at least one embodiment, the NPCA supporting DPS STA can operate in a lower power mode after performing the switch to the backup primary channel. In such embodiments, the AP can initiate transmission to the DPS STA on the backup primary channel with a DPS initial control frame with an applicable DPS padding delay, if the AP wants the DPS STA to transition to the higher power mode. In at least one embodiment, the DPS non-AP STA can indicate when enabling the NPCA operation whether the DPS non-AP STA will operate in the low power mode or the high-power mode after performing the NPCA switch. In such embodiments, the DPS non-AP STA can indicate the high-power or low power mode in a frame that the DPS non-AP STA transmits to indicate participation in the NPCA operation.

In at least one embodiment, the DPS non-AP STA can be capable of transmitting or receiving, during transmissions on the NPCA backup primary channel, on a ‘X’ MHz channel that overlaps with the NPCA backup primary channel, where ‘X’ is a high-power mode bandwidth of the non-AP STA. In at least one embodiment, the DPS non-AP STA is capable of transmission or reception on the sub-bands of the NPCA TXOP that overlaps with the ‘X’ MHz channel that overlaps the primary channel. In at least one embodiment, the DPS non-AP STA can indicate the bandwidth capability on the NPCA backup primary channel in a frame the DPS non-AP STA transmits to indicate participation in the NPCA operation. In other embodiments, the DSP non-AP STA transmits the indication in a non-AP STA capabilities element. In some embodiments, a resource allocation to a non-AP STA on the NPCA backup primary channel can comply with the indicated bandwidth capability.

In at least one embodiment, an NPCA supporting EMLMR STA can have expanded receive capabilities after performing the NCPA switch to the backup primary channel. In other embodiments, the NPCA supporting EMLMR can have a basic reception capability after performing the NPCA switch to the backup primary channel. In such embodiments, the AP initiates transmission to the NPCA supporting EMLMR STA on the backup primary channel with an initial frame with applicable EMLMR padding delay.

In some embodiments, if an OBSS transmission overlaps with a restricted target wake time service period (R-TWT SP), the SP cannot begin within the backup primary channel. In such embodiments, the SP is deferred until an end of the NAV duration set by the OBSS transmission. Additionally, in such embodiments, a non-AP STA that switches to the backup primary channel can refrain from following a channel access deferral procedure corresponding to R-TWT operations on the backup primary channel.

In at least one embodiment, if the OBSS transmission overlaps with the R-TWT SP and a NAV set by the OBSS transmission is longer than the SP duration, then the AP can initiate the R-TWT SP on the backup primary channel. In some embodiments, the AP can initiate the R-TWT SP specifically for the R-TWTs for which all or some members have indicated NPCA operation capabilities (e.g., or enablement of the NPCA operation capabilities). In some embodiments, the AP can indicate in its broadcast TWT element in beacon frames whether a TWT is capable of being scheduled on the backup primary channel. In such embodiments, for the start of the R-TWT SPs, non-AP STAs that switch to a backup primary channel follow the channel access deferral procedures corresponding to the R-TWT operation on the backup primary channel. In at least one embodiment, the rules described herein for the R-TWT operation can also be applicable for a broadcast TWT and/or an individual TWT.

In some embodiments, a multi-AP negotiation made by an AP on the primary channel may not extend to an NPCA primary channel. In such embodiments, the AP may refrain from transmitting a frame to initiate multi-AP coordination with a neighbor or follow rules corresponding to multi-AP coordination when the AP is operating on the NPCA backup primary channel. For example, in a coordinated R-TWT operation, rules for terminating channel access to protect some R-TWT service periods of the neighboring AP may not be applicable to the NPCA backup primary channel. In another example, the AP may refrain from transmitting a control frame to perform coordinated time-division multiple access (C-TDMA) TXOP sharing with a neighboring AP while the AP is operating on the NPCA backup primary channel. In some embodiments, some of the multi-AP negotiation made by an AP on the primary channel may also extend to the NPCA primary channel. For example, in some coordinated R-TWT operation, the rules for terminating channel access to protect some R-TWT service periods of the neighboring AP may also be applicable to the NPCA backup primary channel.

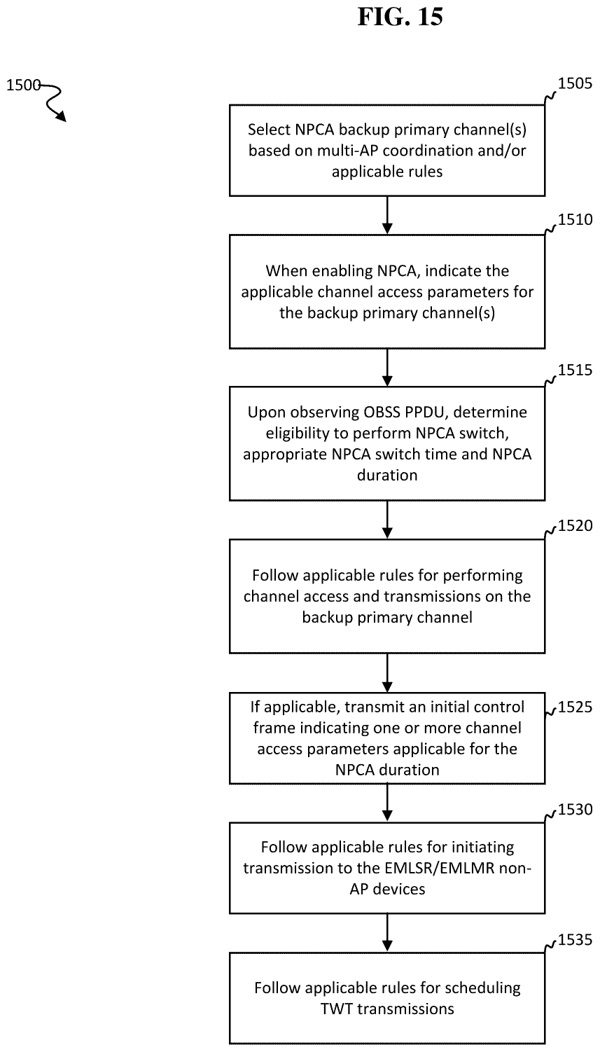

FIG. 15 shows an example process 1500 for non-primary channel access in accordance with an embodiment. For explanatory and illustration purposes, the process 1500 may be performed by an AP. In other embodiments, the process described herein can be performed by an STA. Although one or more operations are described or shown in a particular sequential order, in other embodiments the operations may be rearranged in a different order, which may include performance of multiple operations in at least partially overlapping time periods.

Referring to FIG. 15, the process 1500 may begin in operation 1505. In operation 1505, an AP can select NPCA backup primary channel(s) based on multi-AP coordination and/or applicable rules as described with reference to FIG. 7.

In operation 1510, the AP can indicate applicable channel access parameters for the backup primary channel when enabling NCPA. For example, the AP can transmit a frame for initiating an NPCA operation, the frame indicating the NPCA primary channel and the access parameters as described with reference to FIG. 7-9.

In operation 1515, the AP, upon observing an OBSS PDDU, can determine eligibility to perform an NPCA switch, an appropriate NPCA switch time, and an NPCA duration as described with reference to FIGS. 10-11.

In operation 1520, the AP can follow applicable rules for performing channel access and transmissions on the backup primary channel as described with reference to FIGS. 12A-14.

In operation 1525, if appliable, the AP transmits an initial control frame indicating one or more channel access parameters applicable for the NPCA duration.

In operation 1530, the AP can follow applicable rules for initiating transmission to EMLSR/EMLMR non-AP devices.

In operation 1535, the AP can follow applicable rules for scheduling TWT transmissions.

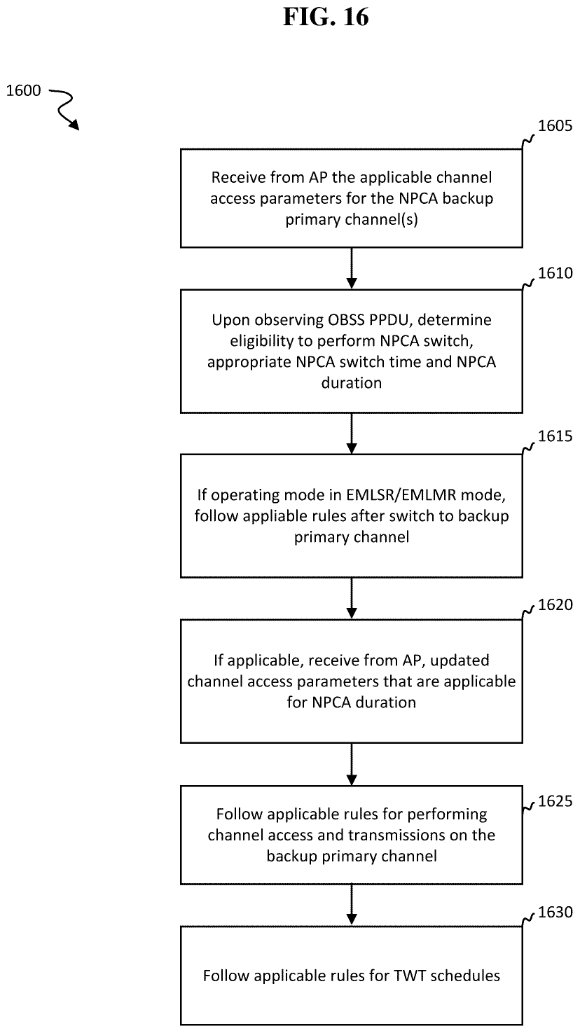

FIG. 16 shows an example process 1600 for non-primary channel access in accordance with an embodiment accordance with an embodiment. For explanatory and illustration purposes, the process 1600 may be performed by an STA. In other embodiments, the process described herein can be performed by an AP. Although one or more operations are described or shown in a particular sequential order, in other embodiments the operations may be rearranged in a different order, which may include performance of multiple operations in at least partially overlapping time periods.

Referring to FIG. 16, the process 1600 may begin in operation 1605. In operation 1605, a STA receives, from an AP, applicable channel access parameters for the NPCA backup primary channel(s) as described with reference to FIGS. 7-9.

In operation 1610, the STA, upon observing an OBSS PPDU, can determine eligibility to perform an NPCA switch, an appropriate NPCA switch time, and an NPCA duration as described with reference to FIGS. 10-11.

In operation 1615, if the STA is operating in an EMLSR or EMLMR mode, the STA can follow the applicable rules after a switch to the NPCA backup primary channel.

In operation 1620, the STA can, if applicable, receive from the AP updated channel access parameters that are applicable for the NPCA duration.

In operation 1625, the STA can follow appliable rules for performing channel access and transmissions on the backup primary channel as described with reference to FIGS. 12A-14.

In operation 1630, the STA can follow applicable rules for TWT schedules.

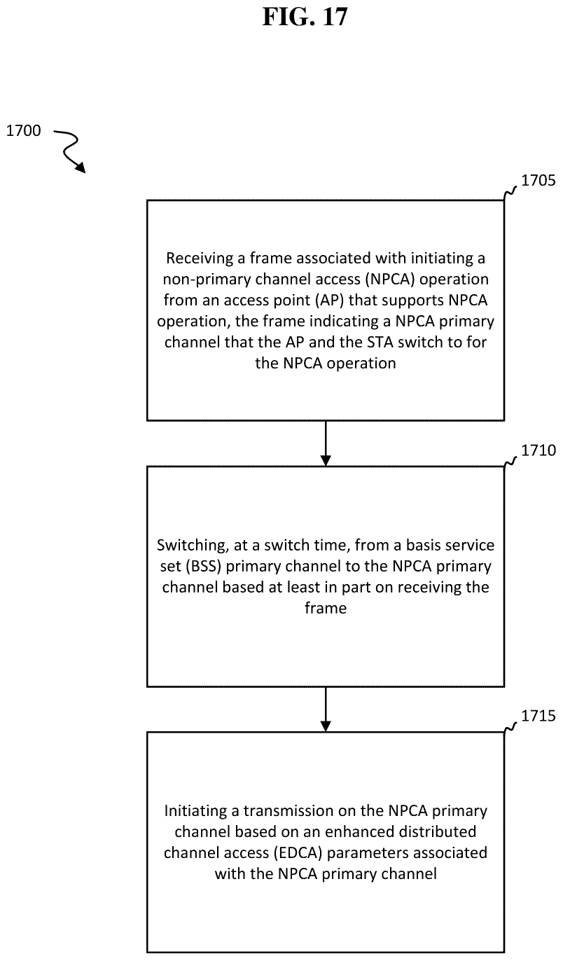

FIG. 17 shows an example process 1700 for using an expanded common and user information field in trigger frames in accordance with an embodiment accordance with an embodiment. For explanatory and illustration purposes, the process 1700 may be performed by a trigger frame recipient (e.g., an AP or an STA). Although one or more operations are described or shown in a particular sequential order, in other embodiments the operations may be rearranged in a different order, which may include performance of multiple operations in at least partially overlapping time periods.

Referring to FIG. 17, the process 1700 may begin in operation 1705. In operation 1705, receiving a frame associated with initiating a non-primary channel access (NPCA) operation from an access point (AP) that supports NPCA operation, the frame indicating a NPCA primary channel that the AP and the STA switch to for the NPCA operation. In at least one embodiment, the frame includes information indicating one or more channels that are punctured—e.g., the frame could include a disabled subchannel bitmap. In one embodiment, the frame includes an indication of a deferral period the STA is to wait upon being ready to transmit on the NPCA primary channel before initiating a transmit opportunity (TXOP). That is, the AP can indicate the deferral period the STA should wait upon being ready on the NPCA primary channel before initiating a TXOP.

At operation 1710, the STA can perform switching, at a switch time, from a basic service set (BSS) primary channel to the NPCA primary channel based at least in part on receiving the frame.

At operation 1715, the STA can perform initiating a transmission on the NPCA primary channel based on an enhanced distributed channel access (EDCA) parameters associated with the NPCA primary channel. In at least one embodiment, the STA can initiate the transmission after the switch at the switch time by initializing a contention window based on the EDCA parameters associated with the NPCA primary channel. That is, the STA can select the contention window to a first value and select a second value between zero and the first value for a backoff counter associated with the NPCA primary channel as described with reference to FIG. 7.

In at least one embodiment, the STA can further perform transmitting one or more physical layer protocol data units (PPDUs) on one or more channels during the NPCA operation, wherein the one or more channels include at least the NPCA primary channel, the one or more channels are within a BSS bandwidth, and the one or more channels do not include a channel that is punctured. In some embodiments, the STA can perform initiating a transmission on the NPCA primary channel to the AP after a NPCA switching delay time of the AP elapses since the switch time. That is, as described with reference to FIG. 12A-14, the STA can wait to initiate a transmit opportunity (TXOP) until all STAs and the AP have made the switch to the NPCA primary channel. In one embodiment, an AP initiates transmission on the NPCA primary channel to the one or more associated STAs after an NPCA switching time delay of each STA of the one or more STAs, which are expected recipients of the transmission, elapses since a switch time associated with transitioning from the BSS primary channel to the NPCA primary channel.

In at least one embodiment, the STA can perform receiving, from the AP, an indication enabling a mode of operation for the NPCA operation, wherein the mode of operation disables untriggered uplink (UL) transmissions on the NPCA primary channel by the STA. In one embodiment, the STA can perform receiving, from the AP, a trigger frame soliciting an uplink transmission and initiating a transmit opportunity (TXOP) on the primary channel based on receiving the trigger frame and a mode of operation for the NPCA operation. That is, the AP can set a mode of operation where untriggered uplink (UL) transmissions are not allowed by non-AP STA. In such embodiments, the STA can wait until receiving a trigger-based transmission before initiating a TXOP.

In at least one embodiment, the STA can further perform transmitting, to the AP, an NPCA initial control frame that solicits a response from the AP, and receiving, from the AP, a downlink frame in response to the NPCA initial control frame.

In one embodiment, the STA can further perform detecting a transmission on the NPCA primary channel, wherein the transmission is not from within a BSS associated with the AP. The STA can further perform determining a duration of the transmission the NPCA primary channel, where if the duration of the transmission is above the threshold, switching to the BSS primary channel and if the duration of the transmission is below the threshold, remaining on the NPCA primary channel.

By using the procedures described herein for an NPCA operation, an AP and STA can perform an NPCA switch to the backup primary channel and follow channel access rules to transmit on the backup primary channel while the primary channel is busy or unavailable.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
receiving a frame associated with initiating a non-primary channel access (NPCA) operation from an access point (AP) that supports NPCA operation, the frame indicating a NPCA primary channel that the AP and the STA switch to for the NPCA operation;
switching, at a switch time, from a basic service set (BSS) primary channel to the NPCA primary channel based at least in part on receiving the frame; and
initiating a transmission on the NPCA primary channel based on an enhanced distributed channel access (EDCA) parameters associated with the NPCA primary channel.

2. The STA of claim 1, wherein the initiating the transmission after switching at the switch time includes initializing a contention window based on the EDCA parameters associated with the NPCA primary channel.

3. The STA of claim 1, wherein the frame includes information indicating one or more channels that are punctured.

4. The STA of claim 1, wherein the processor is further configured to cause:
transmitting one or more physical layer protocol data units (PPDUs) on one or more channels during the NPCA operation, wherein the one or more channels include at least the NPCA primary channel, the one or more channels are within a BSS bandwidth, and the one or more channels do not include a channel that is punctured.

5. The STA of claim 1, wherein the processor is further configured to cause:
initiating a transmission on the NPCA primary channel to the AP after a NPCA switching delay time of the AP elapses since the switch time.

6. The STA of claim 1, wherein the processor is further configured to cause:
receiving, from the AP, an indication enabling a mode of operation for the NPCA operation, wherein the mode of operation disables untriggered uplink (UL) transmissions on the NPCA primary channel by the STA.

7. The STA of claim 1, wherein the processor is further configured to cause:
receiving, from the AP, a trigger frame soliciting an uplink transmission; and
initiating a transmit opportunity (TXOP) on the NPCA primary channel based on receiving the trigger frame and a mode of operation for the NPCA operation.

8. The STA of claim 1, wherein the processor is further configured to cause:
transmitting, to the AP, an NPCA initial control frame that solicits a response from the AP; and
receiving, from the AP, a downlink frame in response to the NPCA initial control frame.

9. The STA of claim 1, wherein the frame further includes an indication of a deferral period the STA is to wait upon being ready to transmit on the NPCA primary channel before initiating a transmit opportunity (TXOP).

10. The STA of claim 1, wherein the processor is further configured to cause:
detecting a transmission on the NPCA primary channel, wherein the transmission is not from within a BSS associated with the AP;
determining a duration of the transmission the NPCA primary channel; and
comparing the duration of the transmission with a threshold value, wherein:
if the duration of the transmission is above the threshold, switching to the BSS primary channel; or
if the duration of the transmission is below the threshold, remaining on the NPCA primary channel.

11. An access point (AP) in a wireless network, comprising:
a memory; and
a processor coupled to the memory, the processor configured to cause:
transmitting a frame associated with initiating a non-primary channel access (NPCA) operation to one or more associated stations (STAs) that support NPCA operation, the frame indicating an NPCA primary channel that the AP and the STA switch to from a basic service set (BSS) primary channel for the NPCA operation; and
initiating a transmission on the NPCA primary channel to initiate a data exchange with the one or more associated STAs based on an enhanced distributed channel access (EDCA) parameters associated with the NPCA primary channel.

12. The AP of claim 11, wherein the frame includes information indicating one or more channels that are punctured.

13. The AP of claim 11, wherein the processor is further configured to cause:
transmitting one or more physical layer protocol data units (PPDUs) on one or more channels during the NPCA operation, wherein the one or more channels include at least the NPCA primary channel, the one or more channels are within a BSS bandwidth, and the one or more channels do not include a channel that is punctured.

14. The AP of claim 11, wherein the AP initiates the transmission on the NPCA primary channel to the one or more associated STAs after an NPCA switching delay time of each STA of the one or more associated STAs, which are expected recipients of the transmission, elapses since a switch time associated with transitioning from the BSS primary channel to the NPCA primary channel.

15. The AP of claim 11, wherein the processor is further configured to cause:
transmitting, to the one or more associated STAs, an indication enabling a mode of operation for the NPCA operation, wherein the mode of operation disables untriggered uplink (UL) transmissions on the NPCA primary channel by the STA.

16. The AP of claim 11, wherein the processor is further configured to cause:
transmitting, to the one or more associated STAs, a trigger frame soliciting an uplink transmission; and
receiving, from the one or more associated STAs, the uplink transmission based at least in part on transmitting the trigger frame and a mode of operation for the NCPA.

17. A method performed by a station (STA) in a wireless network, comprising:
receiving a frame associated with initiating a non-primary channel access (NPCA) operation from an access point (AP) that supports NPCA operation, the frame indicating a NPCA primary channel that the AP and the STA switch to for the NPCA operation;
switching, at a switch time, from a basic service set (BSS) primary channel to the NPCA primary channel based at least in part on receiving the frame; and
initiating a transmission on the NPCA primary channel based on an enhanced distributed channel access (EDCA) parameters associated with the NPCA primary channel.

18. The method of claim 17, wherein the switching at the switch time includes initializing a contention window based on the EDCA parameters associated with the NPCA primary channel.

19. The method of claim 17, wherein the frame includes information indicating one or more channels that are punctured.

20. The method of claim 17, further comprising:
transmitting one or more physical layer protocol data units (PPDUs) on one or more channels during the NPCA operation, wherein the one or more channels include at least the NPCA primary channel, the one or more channels are within a BSS bandwidth, and the one or more channels do not include a channel that is punctured.
